(19) United States
(12) Patent Application Publication
(10) Pub. No.: US 2011/0142531 A1
(43) Pub. Date: Jun. 16, 2011

(54) Sealing System and Method

(76) Inventors: NORMAN BINZ DEWALCH, HOUSTON, TX (US); JOHN EDWARD STAOHOWLAK, JR., HOUSTON, TX (US); ZACHARY LEROY DAVIDSON, HOUSTON, TX (US)

(21) Appl. No.: 12/822,162

(22) Filed: Jun. 23, 2010

Related U.S. Application Data
(63) Continuation of application No. 11/982,087, filed on Nov. 1, 2007, now abandoned.
Application No. 11/982,087 is a continuation-in-part of application No. 11/824,156, filed on Jun. 26, 2007.
Application No. 11/824,156 is a continuation-in-part of application No. 11/698,616, filed on Jan. 25, 2007.
Application No. 11/698,616 is a continuation-in-part of application No. 11/444,550, filed on May 31, 2006, now abandoned.
Application No. 11/444,550 is a continuation-in-part of application No. PCT/US06/21137, filed on May 31, 2006.
(60) Provisional application No. 60/685,322, filed on May 31, 2005.

(51) Int. Cl. F16B 17/00

(52) U.S. Cl. 403/2

(57) ABSTRACT

An apparatus for connecting a plurality of structures, such as ends of a sealing ring, with each end defining an aperture therein and with the ring being adapted to mount a meter to a meter box structure. The apparatus comprises a locking pin with a distal end adapted to be insertable through each of the apertures of the first and second ends of the ring. The locking pin comprises a head member having at least an engageable end and a fracturable member. The locking pin further comprises a shaft portion having the distal end. The apparatus further comprises a lock housing adapted to retain at least a part of the shaft portion such that the first and second ends of the ring are connected between the head member of the locking pin and the lock housing. The head member has an outer surface adapted to receive at least two opposing forces, the at least two opposing forces being of sufficient magnitude to break the fracturable member. A lock removal tool is adapted to receive and fracture a portion of the locking pin, enabling removal of the lock assembly from the meter box sealing ring. In an example embodiment an apparatus and method is provided for securing at least one structure or a plurality of structures, used with a utility service enclosure, or for example, a meter box locking ring having, for example, flanged ends or used to seal for example, utility enclosures, meter boxes or trucking, shipping, airline or other transportation containers or enclosures. An example embodiment also provides a tamper-evident locking apparatus or seal that is adapted to indicate tampering.

### CROSS-REFERENCE TO RELATED APPLICATIONS

This application is a continuation-in-part of application Ser. No. 11/824,156, filed Jun. 26, 2007 which is a continuation-in-part of application Ser. No. 11/698,616, filed Jan. 25, 2007, which is a continuation-in-part of application Ser. No. 11/444,550, filed May 31, 2006, which claims the benefit of U.S. Provisional Patent Application No. 60/685,322, filed May 31, 2005. This application also is a continuation-in-part of International Application No. PCT/US2006/021137, filed May 31, 2006. This application also claims the benefit of U.S. Provisional Patent Application No. 60/997,326, filed Sep. 30, 2007.

The instant application claims priority to each of the above-referenced applications. All written material, figures, and other disclosure in each of the above-referenced applications to the fullest extent permitted are hereby incorporated by reference.

### BACKGROUND OF THE INVENTION

The present invention relates generally to a locking apparatus, and more specifically, it relates to a locking apparatus for securing at least one structure or a plurality of structures used with a utility service enclosure, or for example, a watthour meter socket ring to prevent the separation of two opposing members of the watthour meter socket box ring, or used to seal for example, a trucking, shipping, an airline or other transportation or security container.

In the electric utility industry, for example, a locking apparatus or seal is useful to secure access panels of enclosures containing electrical or metering equipment. Such a locking apparatus or seal also ideally includes tamper-evident features to indicate unwanted tampering with the seal or attempts to access a secured electrical meter box or the like.

Electrical service providers generally deliver electricity to their customers via power lines buried underground or distributed along poles or towers overhead. The provider's power lines are usually distributed from a power generation station to numerous sets of customer lines, so that customers can then use the power to satisfy their various electrical needs. To measure delivered power so that customers can be billed in proportion to their usage, service providers typically terminate their power lines at a customer's home or business facility through a metered socket box, various designs for which are well known.

A meter box is generally used by electric utility companies, however the invention herein may be used with other utility service enclosures in the gas, water, cable, TV utility industries, or in shipping or other industries as well.

An example of one previously known meter box consists of two sets of electrical posts, with a provider's transmission lines being connected to one set of posts, and the customer's service lines to the other set. In order to measure the amount of electricity a customer uses, the meter box is configured to accept a watt-hour meter or another electricity usage measurement device, which, when plugged into the socket box, permits transmission of electricity from the provider to the customer and allows the amount of transmitted electricity to be accurately measured, so that the provider can charge the customer for power usage at an appropriate rate.

Various designs and uses for watthour meters are also well known, and all such designs and uses are incorporated by reference into the teachings of the present invention. The present invention is also applicable in situations where the customer's service lines are routed from the meter box to a breaker box so that electricity can be distributed to multiple service locations using additional sets of electrical lines or wires.

Presently, there are various types of meter socket boxes, each distinguished by the manner in which the meter is secured in place once it has been plugged into an electrical socket disposed in the meter box. For example, a ringed-type meter box fitted with a flanged front cover is known, within which a watthour meter is disposed so that a head portion of the meter passes out through a flanged opening in the front cover. In this configuration, the meter is generally held in place using an annular, lockable sealing ring. However, with this type of design, high lock cost and operator “key control” may be a potential problem. Moreover this type of design may require the use of special tools and structures to secure a ring locking device and may require used of more than one hand to retain or engage the locking device.

In an attempt to overcome some of these shortcomings, there destructible locks that can be installed on ring-type meter socket boxes. Several examples of patents which disclose attempts to solve some of the above problems are set forth as follows.

U.S. Pat. No. 5,161,838 to Ely, et al., entitled “Locking Assembly,” is directed to a locking assembly adapted for locking first and second members together, the assembly including a housing member and a stud member, the housing member being adapted to receive the stud member and permanently lock the stud member in the housing member, the assembly including a frangible portion, such that a part of the assembly is adapted to be broken away from a remainder of the assembly to permit removal of the assembly from the first and second members. This reference is incorporated by reference herein.

U.S. Pat. No. 6,406,074 to Mahaney, entitled “Destructible Locking Device,” sets forth a locking device for interlocking two members having aligned openings extending therethrough. The device includes a hollow cap and a pin with an enlarged head at one end and a nose at the opposite end. The pin is insertable through the aligned openings of the members, with its nose received in interlocked engagement within the cap, and with the two members captured between the cap and the enlarged head of the pin. A frangible portion of the pin is severable in response to relative rotation between its nose and enlarged head to thereby destructively disassemble the locking device. This reference is incorporated by reference herein.

U.S. Pat. No. 5,413,393 to Georgopoulos et al., entitled “Destructible Locking Device,” is directed to a self locking reusable rod seal which includes a case hardened stamped frustro-conical member comprising a C-shaped section from which two like opposing arcuate segments are cantilevered. The member is located and secured for axial displacement in a frustro-conical bore of a case hardened steel housing. The segments have axially spaced ridges, the end most ones of which grip a rod in the bore thereof, the rod axially displacing the member when the rod is displaced in opposite directions relative to the housing. The rod has circumferential axially spaced grooves. The member ridges engage the grooves so as to be pulled by the axial displacement of the rod. The ridges and grooves are resiliently engaged and when the member is displaced toward one end of the housing bore, the ridges disengage and when the member is displaced toward the other end of the bore, the ridges are wedged against the rod grooves. The rod has a head at one end which with the seal lock a hasp therebetween by limiting displacement of the rod toward the one housing bore end.

There remains a need for a locking apparatus and method for securing at least one structure or a plurality of structures, used with a utility service enclosure, or for example, a meter box locking ring having, for example, flanged ends or used to seal for example, utility enclosures, meter boxes or trucking, shipping, airline or other transportation containers or enclosures. There is a need for a tamper-evident locking apparatus that is adapted to indicate tampering. There is also a need for a locking or securing device that can be “locked” without the need for special tools and “unlocked” only one time by using a special or complementary tool, such that when the locking apparatus is “unlocked,” it is rendered ineffective as a future locking device. There is a further need for a locking or securing device that may be retained or engaged using one hand.

Those of skill in the art will appreciate the example embodiments of the present invention which addresses the above needs and other significant needs the solution to which are discussed hereinafter.

### SUMMARY OF THE INVENTION

An object of the present invention is to secure a watthour meter box sealing ring to a watthour meter box.

Another object of the present invention is to provide a locking assembly that can be installed without special tools.

Another object of the present invention is to provide a locking assembly that can be installed only one time.

Another object of the present invention is to provide a locking assembly that when broken, cannot be reinstalled.

Another object of the present invention is to provide a locking assembly that can be removed with a special lock removal tool.

Another object of the present invention is to provide means to prevent the locking assembly removal without a special lock removal tool.

Another object of the present invention is to provide a lock removal tool to be used with the locking assembly.

Another object of the present invention is to provide a lock removal tool that can be actuated with one hand.

Another object of the present invention is to provide a lock removal tool that when used to open or “unlock” a locking assembly, renders the locking assembly useless.

These and other objects, features, and advantages of the present invention will become apparent from the drawings, the descriptions given herein, and the appended claims. However, it will be understood that the above-listed objectives and/or advantages of the invention are intended only as an aid in quickly understanding aspects of the invention, are not intended to limit the invention in any way, and therefore do not form a comprehensive or restrictive list of objectives, and/or features, and/or advantages. Accordingly the present invention provides a locking apparatus for securing at least one structure or a portion of utility service enclosure such as, for example, a watthour meter socket ring to prevent the separation of two opposing members of the watthour meter socket box ring, so as to address the needs as described above.

The general purpose of the present invention, which will be described subsequently in greater detail, is to secure at least one structure or a plurality of structures, to lock a utility service enclosure, such as for example, a meter box locking ring having flanged ends.

One example embodiment the invention includes at least a lock assembly and lock removal tool. The lock assembly generally includes at least a locking pin and a lock housing. The lock housing further includes at least an aperture and a retaining member. The locking pin further includes at least a shaft portion and a head member. The head member of the locking pin further includes at least a fracturable portion. The lock housing is adapted to permanently receive the shaft portion of the locking pin when the lock assembly is in the “locked” position. The lock removal tool is generally comprised of two actuating handles, a base member and pivoting member that are joined and communicate through a common fulcrum pin, and an actuating pin. The lock removal tool is adapted to receive the head member of the locking pin. As the lock removal tool is actuated, a ring portion is removed from the head member of the locking pin, thus enabling the lock assembly to be removed or “unlocked” from the sealing ring, and consequently allowing for sealing ring removal from the watt-hour meter socket box.

Another example embodiment of the present invention includes at least a locking apparatus for securing at least one structure.

Another example embodiment provides an apparatus for creating a tamper-evident seal by securably connecting a plurality of structures, each of the plurality of structures defining an aperture therein, the apparatus including at least a locking pin insertable into each of the apertures of the plurality of structures, wherein the locking pin comprises a shaft portion, a fracturable member, and a head section having an engageable end; and a lock housing adapted to retain at least a part of the shaft portion, the plurality of structures being connected between a portion of the locking pin and the lock housing, wherein the head section has a structural configuration adapted to receive at least two opposing forces, the at least two opposing forces being of sufficient magnitude to break the fracturable member.

In another example embodiment of the apparatus a portion of the head section is adapted to receive a first force while the engageable end is adapted to receive a second force opposing the first force, the first and second forces being of sufficient magnitude to break the fracturable member.

In another example embodiment of the apparatus a complementary tool adapted to manipulate the head section to break the fracturable member.

In another example embodiment of the apparatus a head section has an outer surface, with the complementary tool further including at least an actuator housing defining an encapsulating cavity having an interior surface adapted to capture the head section, the outer surface of the head section being complementary to the interior surface of the encapsulating cavity, the actuator housing comprising a force-exerting structure to bear against the engageable end to break the fracturable member.

In another example embodiment of the apparatus a complementary tool is adapted to manipulate the head section to break the fracturable member, the complementary tool having structure adapted to manipulate at an outer surface of the head section.

Another example embodiment provides a method for creating a tamper-evident seal by securably connecting a plurality of structures, each of the plurality of structures defining an aperture therein, the method including at least: inserting a locking pin into each of the apertures of the plurality of structures, wherein the locking pin comprises a shaft portion, a fracturable member, and a head section having an engageable end; and retaining at least a part of the shaft portion with a lock housing, the plurality of structures being connected between a portion of the locking pin and the lock housing, wherein the head section has a structural configuration adapted to receive at least two opposing forces, the at least two opposing forces being of sufficient magnitude to break the fracturable member.

In another example embodiment of the method a portion of the head section is adapted to receive a first force while the engageable end is adapted to receive a second force opposing the first force, the first and second forces being of sufficient magnitude to break the fracturable member.

In another example embodiment of the method the step includes manipulating the head section to break the fracturable member.

In another example embodiment of the method the step of manipulating the head section further includes at least: capturing the head section; and bearing against the engageable end to break the fracturable member.

An another example embodiment of an apparatus method includes at least an apparatus for connecting and disconnecting first and second ends of a ring, the ring being adapted to mount a meter to a meter box structure, each of the first and second ends of the ring defining an aperture therein, the apparatus including at least: a locking pin having a distal end adapted to be insertable through each of the apertures of the first and second ends of the ring, wherein the locking pin comprises a head member having at least an engageable end and a fracturable member, the locking pin further comprising a shaft portion having the distal end, the fracturable member being disposed intermediate the engageable end and the distal end of the locking pin; and a lock housing adapted to retain at least a part of the shaft portion, the first and second ends of the ring being connected between the head member of the locking pin and the lock housing, wherein the head member has an outer surface adapted to receive at least two opposing forces, the at least two opposing forces being of sufficient magnitude to break the fracturable member.

In another example embodiment of the apparatus a portion of the head member is adapted to receive a first force while the engageable end is adapted to receive a second force opposing the first force, the first and second forces being of sufficient magnitude to break the fracturable member.

In another example embodiment of the apparatus the apparatus includes at least a complementary tool adapted to manipulate the outer surface of the head member to break the fracturable member.

In another example embodiment of the apparatus the complementary tool further includes at least: an actuator housing defining an encapsulating cavity having an interior surface adapted to capture the head member, the outer surface of the head member being complementary to the interior surface of the encapsulating cavity, the actuator housing comprising a force-exerting structure to in general, axially bear against the engageable end to break the fracturable member.

In another example embodiment of the apparatus the fracturable member is disposed immediately adjacent at least one of the rings.

An another example embodiment of the apparatus includes at least a complementary tool adapted to manipulate the head member to break the fracturable member, the complementary tool having structure adapted to manipulate the outer surface of the head member.

An another example embodiment includes a method for connecting and disconnecting first and second ends of a ring, the ring being adapted to mount a meter to a meter box structure, each of the first and second ends of the ring defining an aperture therein, the method includes at least: inserting a distal end of a locking pin through each of the apertures of the first and second ends of the ring, wherein the locking pin comprises a head member having at least an engageable end and a fracturable member, the locking pin further comprising a shaft portion having the distal end, the fracturable member being disposed intermediate the engageable end and the distal end of the locking pin; and retaining at least a part of the shaft portion with a lock housing, the first and second ends of the ring being connected between the head member of the locking pin and the lock housing; wherein the head member has an outer surface adapted to receive at least two opposing forces, the at least two opposing forces being of sufficient magnitude to break the fracturable member.

In another example embodiment of the method a portion of the head member is adapted to receive a first force while the engageable end is adapted to receive a second force opposing the first force, the first and second forces being of sufficient magnitude to break the fracturable member.

Another example embodiment of the method further includes at least the step of manipulating the outer surface of the head member to break the fracturable member.

In another example embodiment of the method the step of manipulating the head member further includes at least: capturing the head member; and in general, axially bearing against the engageable end to break the fracturable member.

In another example embodiment of the method the step of manipulating the head member requires the use of a complementary tool.

In another example embodiment of the method the fracturable member is disposed immediately adjacent at least one of the rings.

Another example embodiment of the method further includes at least the step of manipulating the head member with a complementary tool to break the fracturable member, the complementary tool having structure adapted to manipulate the outer surface of the head member.

Another example embodiment of a system is provided for creating a tamper-evident seal by securably connecting a plurality of structures, each of the plurality of structures defining an aperture therein, the system including at least: means for positioning a locking pin having a distal end insertable through each of the apertures of the plurality of structures, wherein the locking pin comprises a head member having at least an engageable end and a fracturable member, the locking pin further comprising a shaft portion having the distal end, the fracturable member being disposed intermediate the engageable end and the distal end of the locking pin; and means for retaining at least a part of the shaft portion with a lock housing, the plurality of structures being securably connected between the head member of the locking pin and the lock housing.

In another example embodiment of the system a portion of the head member is adapted for receiving at least two opposing forces, the at least two opposing forces being of sufficient magnitude to break the fracturable member.

Another example embodiment of the system further includes at least means for manipulating the head member to break the fracturable member.

In another example embodiment of the system means for manipulating the head member further includes at least: means for capturing the head member; and means for, in general, axially bearing against the engageable end to break the fracturable member.

In another example embodiment of the system the means for manipulating the head member is performable by means for selectively bearing only against the head member rather than the head member and another structure.

In another example embodiment of the system the means for manipulating the head member is performable by means for selectively bearing against only the head member rather than both the head member and the lock housing.

In another example embodiment of the system the means for manipulating the head member is performed from only one side of the plurality of structures.

In another example embodiment of the system the means for manipulating the head member further comprises means for applying a first force to a portion of the head member and means for applying a second force to the engageable end, the second force opposing the first force, the first and second forces being of sufficient magnitude so as to break the fracturable member.

In another example embodiment of the system the means for manipulating the head member comprises means for applying a resultant generally axial force against a portion of the head member, the resultant generally axial force being of sufficient magnitude to break the fracturable member so as to pull the head member away from the engageable end.

Another example embodiment of the system further includes at least means for separating a part of the head member comprising the fracturable member from the engageable end and the shaft portion.

In another example embodiment of the system the means for manipulating the head member includes at least a complementary tool.

In another example embodiment of the system the means for manipulating the head member is performable with one hand.

In another example embodiment of the system the complementary tool comprises first and second handles and an actuator housing, the first handle connected to the actuator housing and the second handle pivotably connected to the actuator housing, the second handle being in functional cooperation with the actuator housing, the actuator housing adapted to capture the head member and to bear against the engageable end to break the fracturable member when the second handle is actuated.

In another example embodiment of the system the second handle is adapted to be pivoted away from the first handle to an open configuration, the actuator housing adapted to capture the head member, and wherein, in response to a force applied to the second handle to pivot the second handle toward the first handle to a closed configuration, the actuator housing is adapted to in general, axially bear against the engageable end so as to break the fracturable member.

In another example embodiment of the system the actuator housing further comprises a force-exerting structural means adapted to convert a pivoting rotational force to a generally translational force, the force being of sufficient magnitude to in general, axially bear against the engageable end to break the fracturable member.

In another example embodiment of the system, in response to a force applied to the first and second handles, the first and second handles and actuator housing are cooperatively adapted to transmit a mechanically multiplied generally translational force to the engageable end, the force being of sufficient magnitude to break the fracturable member.

In another example embodiment of the system the actuator housing comprises a force-exerting structural means, the force-exerting structural means comprising a force-exerting means and a force-responsive means, the force-exerting means adapted to be carried along a curved path and simultaneously roll during engagement with a surface of the force-responsive means when the second handle is pivoted towards the closed configuration, the force-responsive means adapted for generally translational movement during engagement by the force-exerting means so as to transmit a resultant generally translational force to the engageable end, the force being of sufficient magnitude to break the fracturable means.

In another example embodiment of the system the force-responsive means is an actuating pin and the force-exerting means is a cam.

In another example embodiment of the system the actuator housing is configured so as to define an encapsulating cavity adapted to securely confine the part of the head member after using the means for manipulating the head member to break the fracturable member.

In another example embodiment of the system the second handle is frictionally pivotable with respect to the actuator housing so as to prevent unwanted pivoting of the second handle to an open position, and wherein a part of the head member is prevented from being inadvertently released after using the means for manipulating the head member to break the fracturable member.

In another example embodiment of the system the second handle is pivotable to a stowed configuration, with the second handle being substantially aligned with the first handle so as to facilitate storage and handling.

Another example embodiment of the system, further includes at least means for capturing a part of the head member within the tool after using the means for manipulating the head member to break the fracturable member.

Another example embodiment of the system, further includes at least means for protecting the fracturable member from the engageable end so as to prevent undesired access to the fracturable member.

In another example embodiment of the system the head member further includes at least a structural element adapted to displace the engageable end away from the fracturable member.

In another example embodiment of the system the structural element includes at least a cylindrical standoff member adapted to displace the engageable end from the fracturable member by a selected distance so as to prevent tampering with the fracturable member.

In another example embodiment of the system at least a portion of the head member is hardened to prevent unwanted tampering therewith.

In another example embodiment of the system the lock housing is in functional cooperation with the at least a part of the shaft portion such that the distal end of the shaft portion is adapted to bear against the lock housing, and wherein the lock housing rather than the fracturable member receives any undesired generally translational force transmitted through the engageable end so as to prevent unintended breaking of the fracturable member.

In another example embodiment of the system the lock housing has a longitudinal bore therein defining an opening in communication with a cavity, the cavity having an end wall being selectively displaced from the opening such that the distal end of the at least a portion of the shaft bears against the end wall when any undesired generally translational force is transmitted to the engageable end so as to prevent the undesired generally translational force from being transmitted to the fracturable member.

In another example embodiment of the system the fracturable member is disposed immediately adjacent at least one of the plurality of structures.

In another example embodiment of the system the head member further comprises a head section comprising a ring portion and a force-bearing portion having one end as the engageable end, the force-bearing portion disposed within the ring portion so as to define a circumferentially extending channel therebetween.

In another example embodiment of the system the fracturable member is interposed between the shaft portion and the head section.

In another example embodiment of the system the fracturable member is interposed between the shaft portion and engageable end.

In another example embodiment of the system the means for retaining at least a part of the shaft portion with a lock housing is performable without the use of a tool.

In another example embodiment of the system the plurality of structures comprises first and second ends of a ring adapted to attach a meter to a meter box structure, each of the first and second ends of the ring defining an aperture therein.

An example embodiment of the method provides for creating a tamper-evident seal by securably connecting a plurality of structures, each of the plurality of structures defining an aperture therein, the method comprising: inserting a distal end of a locking pin through each of the apertures of the plurality of structures, wherein the locking pin comprises a head member having at least an engageable end and a fracturable member, the locking pin further comprising a shaft portion having the distal end, the fracturable member being disposed intermediate the engageable end and the distal end of the locking pin; and retaining at least a part of the shaft portion with a lock housing, the plurality of structures being securably connected between the head member of the locking pin and the lock housing.

In another example embodiment of the method a portion of the head member is adapted to receive at least two opposing forces, the at least two opposing forces being of sufficient magnitude to break the fracturable member.

Another example embodiment of the method further includes at least the step of manipulating the head member to break the fracturable member to disconnect the plurality of structures.

In another example embodiment of the method the step of manipulating the head member further includes at least: capturing the head member; and in general, axially bearing against the engageable end to break the fracturable member.

In another example embodiment of the method the step of manipulating the head member is performable by selectively bearing only against the head member rather than the head member and another structure.

In another example embodiment of the method the step of manipulating the head member is performable by selectively bearing against only the head member rather than both the head member and the lock housing.

In another example embodiment of the method the step of manipulating the head member is performed from only one side of the plurality of structures.

In another example embodiment of the method the step of manipulating the head member further comprises applying a first force to a portion of the head member while applying a second force to the engageable end, the second force opposing the first force, the first and second forces being of sufficient magnitude to break the fracturable member.

In another example embodiment of the method the step of manipulating the head member comprises applying a resultant generally axial force against a portion of the head member, the resultant generally axial force being of sufficient magnitude to break the fracturable member so as to pull the head member away from the engageable end.

Another example embodiment of the method further includes at least the step of separating a part of the head member comprising the fracturable member from the engageable end and the shaft portion.

In another example embodiment of the method the step of manipulating the head member requires the use of a complementary tool.

In another example embodiment of the method the step of manipulating the head member using the complementary tool is performable with one hand.

In another example embodiment of the method the complementary tool comprises first and second handles and an actuator housing, the first handle connected to the actuator housing and the second handle pivotably connected to the actuator housing, the second handle being in functional cooperation with the actuator housing, the actuator housing adapted to capture the head member and to bear against the engageable end to break the fracturable member when the second handle is actuated.

In another example embodiment of the method the second handle is adapted to be pivoted away from the first handle to an open configuration, the actuator housing adapted to capture the head member, and wherein, in response to a force applied to the second handle to pivot the second handle toward the first handle to a closed configuration, the actuator housing is adapted to in general, axially bear against the engageable end so as to break the fracturable member.

In another example embodiment of the method the actuator housing further comprises a force-exerting structure adapted to convert a pivoting rotational force to a generally translational force so as to in general, axially bear against the engageable end, the force being of sufficient magnitude to break the fracturable member.

In another example embodiment of the method, in response to a force applied to the first and second handles, the first and second handles and actuator housing are cooperatively adapted to transmit a mechanically multiplied generally translational force to the engageable end, the force being of sufficient magnitude to break the fracturable member.

In another example embodiment of the method the actuator housing comprises a force-exerting structure, the force-exerting structure comprising a force-exerting member and a force-responsive member, the force-exerting member adapted to be carried along a curved path and simultaneously roll during engagement with a surface of the force-responsive member when the second handle is pivoted towards the closed configuration, the force-responsive member adapted for generally translational movement during engagement by the force-exerting member so as to transmit a resultant generally translational three to the engageable end, the three being of sufficient magnitude to break the fracturable member.

In another example embodiment of the method the force-responsive member is an actuating pin and the force-exerting member is a cam.

In another example embodiment of the method the actuator housing is configured so as to define an encapsulating cavity adapted to securely confine the part of the head member after the step of manipulating the head member to break the fracturable member.

In another example embodiment of the method the second handle is frictionally pivotable with respect to the actuator housing so as to prevent unwanted pivoting of the second handle to an open position, and wherein a part of the head member is prevented from being inadvertently released after the step of manipulating the head member to break the fracturable member.

In another example embodiment of the method the second handle is pivotable to a stowed configuration, with the second handle being substantially aligned with the first handle so as to facilitate storage and handling.

Another example embodiment of the method further includes at least the step of capturing a part of the head member within the tool after the step of manipulating the head member to break the fracturable member.

Another example embodiment of the method further includes at least the step of protecting the fracturable member from the engageable end so as to prevent undesired access to the fracturable member.

In another example embodiment of the method the head member further comprises a structural element adapted to displace the engageable end away from the fracturable member.

In another example embodiment of the method the structural element comprises a cylindrical standoff member adapted to displace the engageable end from the fracturable member by a selected distance so as to prevent tampering with the fracturable member.

In another example embodiment of the method at least a portion of the head member is hardened to prevent unwanted tampering therewith.

In another example embodiment of the method the lock housing is in functional cooperation with the at least a part of the shaft portion such that the distal end of the shaft portion is adapted to bear against the lock housing, and wherein the lock housing rather than the fracturable member receives any undesired generally translational force transmitted through the engageable end so as to prevent unintended breaking of the fracturable member.

In another example embodiment of the method the lock housing has a longitudinal bore therein defining an opening in communication with a cavity, the cavity having an end wall being selectively displaced from the opening such that the distal end of the at least a portion of the shaft bears against the end wall when any undesired generally translational force is transmitted to the engageable end so as to prevent the undesired generally translational force from being transmitted to the fracturable member.

In another example embodiment of the method the fracturable member is disposed immediately adjacent at least one of the plurality of structures.

In another example embodiment of the method the head member further comprises a head section comprising a ring portion and a force-bearing portion having one end as the engageable end, the force-bearing portion disposed within the ring portion so as to define a circumferentially extending channel therebetween.

In another example embodiment of the method the fracturable member is interposed between the shaft portion and the head section.

In another example embodiment of the method the fracturable member is interposed between the shaft portion and engageable end.

In another example embodiment of the method the step of retaining at least a part of the shaft portion with a lock housing is performable without the use of a tool.

In another example embodiment of the method the plurality of structures comprises first and second ends of a ring adapted to attach a meter to a meter box structure, each of the first and second ends of the ring defining an aperture therein.

Another example embodiment of a system is provided for creating a seal, the system including at least: means for uniting a plurality of structures; means for retaining the means for uniting, wherein the plurality of structures is secured between at least a portion of the means for uniting and at least a portion of the means for retaining; and means for enabling direct application of opposing forces by a separate object to the at least a portion of the means for uniting, whereby the at least a portion of the means for uniting may be fractured.

Another example embodiment of a method is provided for creating a seal, the method including at least: uniting a plurality of structures, wherein the uniting is carried out with a fracturable locking pin; retaining at least a part of the fracturable locking pin with a lock housing, wherein the plurality of structures is secured by the fracturable locking pin and the lock housing; enabling concentration of stress at a desired location on the fracturable locking pin; and enabling further concentration of stress at a desired location on the fracturable locking pin, whereby the fracturable locking pin may be selectively fractured.

Another example embodiment of the method includes the step of enabling concentration of stress at a desired location on the fracturable locking pin, so as to, for example in one embodiment, facilitate fracturing the fracturable locking pin.

Another example embodiment of the method includes the step of enabling further concentration of stress at a desired location on the fracturable locking pin, whereby, for example, the fracturable locking pin may be fractured with a desired fracture configuration.

Another example embodiment of the method includes the comprises a shaft portion, and wherein the step of enabling further concentration of stress is carried out by a groove formed in at least a portion of the shaft portion.

Another example embodiment of the method includes a shaft portion, and wherein the step of enabling further concentration of stress is carried out by an annular groove formed in the shaft portion.

Another example embodiment of the method includes first and second shaft sections, a fracturable member disposed between the first and second shaft sections, and a head section.

Another example embodiment of the method includes the step of enabling further concentration of stress on the fracturable member in a region within a projected area of the second shaft section.

Another example embodiment of the method includes the step of enabling further concentration of stress on the fracturable member, in a region within a projected area of the diameter of the second shaft section.

Another example embodiment of the method includes the step of enabling further concentration of stress on the fracturable member, and wherein the enabling further concentration of stress on the fracturable member is in functional cooperation with the relative diameters of the first and second shaft sections.

Another example embodiment of the method includes the step of enabling control of the fracture configuration of the fracturable locking pin.

Another example embodiment of the method provides wherein the portion of the fracturable locking pin is a head member disposed substantially near an outer side of one of the plurality of structures.

In one other example embodiment a seal is provided including at least: a fracturable locking pin adapted to unite a plurality of structures; a housing adapted to retain at least a part of the fracturable locking pin, wherein the plurality of structures may be secureable between a portion of the fracturable locking pin and the housing, and wherein the portion of the fracturable locking pin is adapted to receive direct application of opposing forces by a separate object, whereby the fracturable locking pin may be fractured; and an indication member adapted to reveal evidence of any application of force to the indication member.

In another example embodiment of the seal, the indication member comprises a coating adapted to encapsulate at least some of the fracturable locking pin.

In another example embodiment of the seal, the fracturable locking pin is at least partially surrounded with the indication member.

In another example embodiment of the seal, the indication member further comprises a stress-propagation member adapted to selectively propagate any stress resulting from application of force to the indication member, wherein evidence of any application of force to the indication member may be more clearly revealed.

In another example embodiment of the seal, the stress-propagation member further comprises a protuberance disposed on the portion of the fracturable locking pin.

In another example embodiment of the seal, the portion of the fracturable locking pin comprises a head member having a central region, the protuberance being integrally formed with the indication member and disposed proximate the central region.

In another example embodiment of the seal, the portion of the fracturable locking pin further comprises a head member stress-concentration element disposed in functional cooperation with the indication element to impede propagation of any stress resulting from application of force to the indication member, wherein evidence of any application of force to the indication member disposed proximate the portion of the fracturable locking pin may be more clearly revealed.

In another example embodiment of the seal, the portion of the fracturable locking pin further comprises a head member stress-concentration element integrally disposed in functional cooperation with the indication element

In another example embodiment of the seal, the portion of the fracturable locking pin comprises a head member having a central region, and further comprising a head member stress-concentration element configured to concentrate, or in another embodiment localize, proximate the central region of the head member any stress resulting from application of opposing forces.

In another example embodiment of the seal, the housing further comprises a retainer having a retaining member and a retaining member recess, the retaining member recess adapted to retain the retaining member.

In another example embodiment of the seal, the retaining recess is formed in part by a first wall of the retainer, the first wall being in spaced in opposing relation to an inclined wall oriented at an angle with respect to the first wall, and wherein the first wall is in functional cooperation with the inclined wall so as to reduce the clearance between the retaining member and the retaining recess when the retaining member is retained within the retaining recess, so as to foster hindering access and removal of the retaining member from retaining recess.

In another example embodiment of the seal, the fracturable locking pin further comprises a spacing member adapted to space the portion of the fracturable locking pin away from either a first or second end of a ring when secured between the portion of the fracturable locking pin and the housing.

In another example embodiment of the seal, the fracturable locking pin is adapted to be fractured by only bearing against the portion of the fracturable locking pin rather than the portion of the fracturable locking pin and another structure.

In another example embodiment of the seal, the fracturable locking pin comprises a shaft portion and a fracturable portion, the fracturable portion comprising a fracturable member and a head member having an engagement surface, and wherein the fracturable member is separable from the shaft portion when there is any application of force to the head member.

In another example embodiment of the seal, the portion of the fracturable locking pin is adapted to receive at least two opposing forces, the at least two opposing forces being of sufficient magnitude to break the fracturable member.

In another example embodiment of the seal, the apparatus further comprises a complementary tool adapted to manipulate the outer surface of the head member, wherein the at least two opposing forces of sufficient magnitude may be applied to break the fracturable locking pin.

In another example embodiment of the seal, the complementary tool comprises at least an actuator housing defining a cavity having an interior member adapted to capture the head member, the outer surface of the head member being complementary to the interior member of the cavity, the actuator housing comprising a force-exerting member to in general, axially hear against the portion of the fracturable locking pin to break the fracturable locking pin.

In one other example embodiment an apparatus is provided for securing a ring having first and second ends, the ring being adapted to mount a meter to a meter box structure, each of the first and second ends of the ring defining an aperture therein, the apparatus including at least: a locking pin having a distal end adapted to be insertable through each of the apertures of first and second ends of a ring, wherein the locking pin includes at least a head member having at least an engageable end and a fracturable member, the locking pin further including at least a shaft portion with the distal end, the fracturable member being disposed intermediate the engageable end and the distal end of the locking pin; and a lock housing adapted to retain at least a part of the shaft portion.

In another example embodiment of the apparatus, the head member is adapted to receive at least two opposing forces, the at least two opposing forces being of sufficient magnitude to break the fracturable member.

In another example embodiment of the apparatus, the apparatus further includes at least a complementary tool adapted to manipulate the head member, wherein the at least two opposing forces of sufficient magnitude may be applied to break the fracturable member.

In another example embodiment of the apparatus, the complementary tool includes at least an actuator housing defining a cavity having an interior surface adapted to capture the head member, the outer surface of the head member being complementary to the interior surface of the cavity, the actuator housing including at least a force-exerting structure to in general, axially bear against the engageable end to break the fracturable member.

In another example embodiment of the apparatus, the fracturable member is disposed immediately adjacent at least one of first and second ends of a ring.

In one other example embodiment a system is provided for creating a seal, the system including at least: means for uniting a plurality of structures; means for retaining the means for uniting, wherein the plurality of structures is secured between at least a portion of the means for uniting and at least a portion of the means for retaining; and means for enabling direct application of opposing forces by a separate object to the at least a portion of the means for uniting, whereby the at least a portion of the means for uniting may be fractured.

In one other example embodiment a method is provided for creating a seal, the method including at least: uniting a plurality of structures, wherein the uniting is carried out with a fracturable locking pin; retaining at least a part of the fracturable locking pin with a lock housing, wherein the plurality of structures is secured between a portion of the fracturable locking pin and at least a portion of the lock housing; and enabling direct application of opposing forces by a separate object to the portion of the fracturable locking pin, whereby the fracturable locking pin may be fractured.

These and other objects, features, and advantages of example embodiments of the present invention will become apparent from the drawings, the descriptions given herein, and the appended claims. Further objects are also indicated herein in various example embodiments of the invention. However, it will be understood that the above-listed objectives and/or advantages of example embodiments are intended only as an aid in quickly understanding aspects of the example embodiments, are not intended to limit the embodiments of the invention in any way, and therefore do not form a comprehensive or restrictive list of objectives, and/or features, and/or advantages.

The content and disclosure of each of the following applications/publications to the extent permitted are specifically hereby incorporated by reference: U.S. Provisional Patent Application No. 60/997,326, filed Sep. 30, 2007; U.S. patent application Ser. No. 11/824,156, filed June 26; U.S. patent application Ser. No. 11/698,616, filed Jan. 25, 2007; U.S. patent application Ser. No. 11/444,550, filed May 31, 2006; International Application No. PCT/US2006/021137, filed May 31, 2006; and U.S. Provisional Patent Application No. 60/685,322, filed May 31, 2005.

There has thus been outlined, rather broadly, features of example embodiments of the invention in order that the detailed description thereof may be better understood, and in order that the present contribution to the art may be better appreciated. There are additional features of example embodiments of invention that will be described hereinafter.

In this respect, before explaining at least one example embodiment of the invention in detail, it is to be understood that the example embodiments are not limited in its application to the details of construction and to the arrangements of the components set forth in the following description or illustrated in the drawings. Various example embodiments are capable of other further embodiments and of being practiced and carried out in various ways. Also, it is to be understood that the phraseology and terminology employed herein are for the purpose of the description and should not be regarded as limiting.

To the accomplishment of the above and related objects, example embodiments of the invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the embodiments of the invention will become fully appreciated as the same becomes better understood when considered in conjunction with the accompanying drawings, and wherein:

FIG. 1 is a perspective view of the present invention in the “locked” position, installed onto a watthour meter box sealing ring in accord with one possible embodiment of the present invention.

FIG. 2 is a side-section view of the present invention in the “locked” position, installed onto a watthour meter box sealing ring in accord with one possible embodiment of the present invention.

FIG. 3 is an exploded side view of the present invention showing the path of installation onto a watthour meter box sealing ring.

FIG. 4 is a side-section view of the present invention in the “unlocked” position, installed onto a watthour meter box sealing ring showing the removal path of the ring portion of the fracturable locking pin head.

FIG. 5 is a perspective view of the present invention showing the engagement path of the lock assembly into the lock removal tool in accord with another possible embodiment of the present invention.

FIG. 6 is a perspective view of the present invention showing the engagement path of the lock assembly into the lock removal tool viewed from below in accord with another possible embodiment of the present invention.

FIG. 7 is a front view of the present invention showing the locking assembly removal tool in the open position in accord with another possible embodiment of the present invention.

FIG. 8 is a section view of the present invention in the “locked” position, showing the engagement path into the lock assembly removal tool in accord with another possible embodiment of the present invention.

FIG. 9 is a front view of the present invention showing the locking assembly in the “locked” position, loaded into the lock assembly removal tool in accord with another possible embodiment of the present invention.

FIG. 10 is a side-section view of the present invention showing the locking assembly in the “locked” position, loaded into the lock assembly removal tool in accord with another possible embodiment of the present invention.

FIG. 11 is a front view of the present invention showing the lock assembly and lock removal tool in the “unlocked” position in accord with another possible embodiment of the present invention.

FIG. 12 is a side-section view of the present invention showing the lock assembly and lock removal tool, in the “unlocked” position in accord with another possible embodiment of the present invention.

FIG. 13 is an exploded perspective view of the present invention showing the lock assembly tool in accord with another possible embodiment of the present invention.

FIG. 14 is a side-section view of the present invention shown in the “locked” position, installed onto a watthour meter box sealing ring in accord with another possible embodiment of the present invention.

FIG. 15 is a side-section view of the present invention in the “locked” position, installed onto a watthour meter box sealing ring in accord with another possible embodiment of the present invention.

FIG. 16 is a side-section view of the present invention shown in the “locked” position, installed onto a watthour meter box sealing ring in accord with another possible embodiment of the present invention.

FIG. 17A is a perspective view of another embodiment of the invention.

FIG. 17B is an end view of an embodiment of the invention.

FIG. 17C is a side-section view of an embodiment of the invention.

FIG. 17D is a side view of an embodiment of the invention.

FIG. 18 is a perspective view of an embodiment in the “locked” position, installed onto a watthour meter box sealing ring in accord with one possible embodiment of the present invention.

FIG. 19 is a side-section view of an embodiment in the “locked” position, installed onto a watthour meter box sealing ring in accord with one possible embodiment of the present invention.

FIG. 20 is an exploded side view of an embodiment showing the path of installation onto a watthour meter box sealing ring.

FIG. 21 is a side-section view of an embodiment in the “unlocked” position, installed onto a watthour meter box sealing ring showing the removal path of the ring portion of the fracturable locking pin.

FIG. 22 is a side-section view of an embodiment in the “unlocked” position.

FIG. 22A is a section view of an embodiment of a retaining member of the housing.

FIG. 22B is an exploded view of an embodiment of a retaining member of the housing.

FIG. 23 is a perspective view of an embodiment showing the engagement path of the lock assembly into the lock removal tool in accord with another possible embodiment of the present invention.

FIG. 24 is a perspective view of an embodiment showing the engagement path of the lock assembly into the lock removal tool viewed from below in accord with another possible embodiment of the present invention.

FIG. 25 is a front view of an embodiment showing the locking assembly removal tool in the open position in accord with another possible embodiment of the present invention.

FIG. 26 is a section view of an embodiment in the “locked” position, showing the engagement path into the lock assembly removal tool in accord with another possible embodiment of the present invention.

FIG. 27 is a front view of an embodiment showing the locking assembly in the “locked” position, loaded into the lock assembly removal tool in accord with another possible embodiment of the present invention.

FIG. 28 is a side-section view of an embodiment showing the locking assembly in the “locked” position, loaded into the lock assembly removal tool in accord with another possible embodiment of the present invention.

FIG. 29 is a front view of an embodiment showing the lock assembly and tool in the “unlocked” position in accord with another possible embodiment of the present invention.

FIG. 30 is a side-section view of an embodiment showing the lock assembly and tool, in the “unlocked” position in accord with another possible embodiment of the present invention.

FIG. 31 is an exploded perspective view of an embodiment showing the tool in accord with another possible embodiment of the present invention.

FIG. 32A is a perspective view of another embodiment of the invention.

FIG. 32B is an end view of an embodiment of the invention.

FIG. 32C is a side-section view of an embodiment of the invention.

FIG. 32D is a side view of an embodiment of the invention.

FIG. 33 is an perspective view of an embodiment showing a seal with fracturable locking pin prior to insertion into a housing in accord with a possible embodiment of the present invention.

FIG. 34 is an perspective view of an embodiment showing a seal with fracturable locking pin after insertion into a housing in accord with a possible embodiment of the present invention.

FIG. 35A is a perspective view of another embodiment of the invention.

FIG. 35B is a perspective view of an embodiment of the invention.

FIG. 35C is an exploded section-perspective view of an embodiment of the invention.

FIG. 35D is an exploded section-side view of an embodiment of the invention.

FIG. 35E is a side-section view of an embodiment of the invention.

FIG. 35F is a side-section view of an embodiment of the invention.

FIG. 35G is a side-section view of an embodiment of the invention.

FIG. 35H is a perspective view of another embodiment of the invention.

FIG. 36A is a perspective view of another embodiment of the invention.

FIG. 36B is a perspective view of an embodiment of the invention.

FIG. 36C is a front view of an embodiment of the invention.

FIG. 36D is a side-section view of an embodiment of the invention.

FIG. 36E is a front view of an embodiment of the invention.

FIG. 36F is a side-section view of an embodiment of the invention.

FIG. 36G is an exploded perspective view of an embodiment of the invention.

While various example embodiments of the invention will be described herein, it will be understood that it is not intended to limit the invention to those embodiments. On the contrary, it is intended to cover all alternatives, modifications, and equivalents included within the spirit of the invention.

### DETAILED DESCRIPTION OF THE INVENTION

Turning now descriptively to the drawings, in which similar reference characters denote similar elements throughout the several views, the attached figures illustrate an apparatus for securing a plurality of structures or a portion of a utility service enclosure. For example, in one embodiment, the apparatus is used for securing a watthour meter socket ring so as to prevent the separation of two opposing members of the watthour meter socket box ring. The apparatus may be used for creating a tamper-evident seal by securably connecting a plurality of structures. The apparatus may also be used as a locking assembly with at least one structure as will hereinafter be explained in further detail.

Referring now to FIG. 1, there is shown a securing sealing ring 14 for a ringed-type meter box (not shown). In order to hold a meter (not shown) in place and prevent its removal from the meter box, both the meter and meter base incorporate a corresponding set of flanges (not shown) that are retained together with an annular, lockable sealing ring 14. The lockable sealing ring 14 is designed to encase and captivate the corresponding flanges of the meter and base when the ends 11A, 11B of the sealing ring 14 are held or connected together. There are different types of lock devices for holding or connecting the ends 11A, 11B together. Most devices require a key in order to engage and disengage the sealing ring 14 from the meter and base; this type of lock device can be “locked” and “unlocked” multiple times.

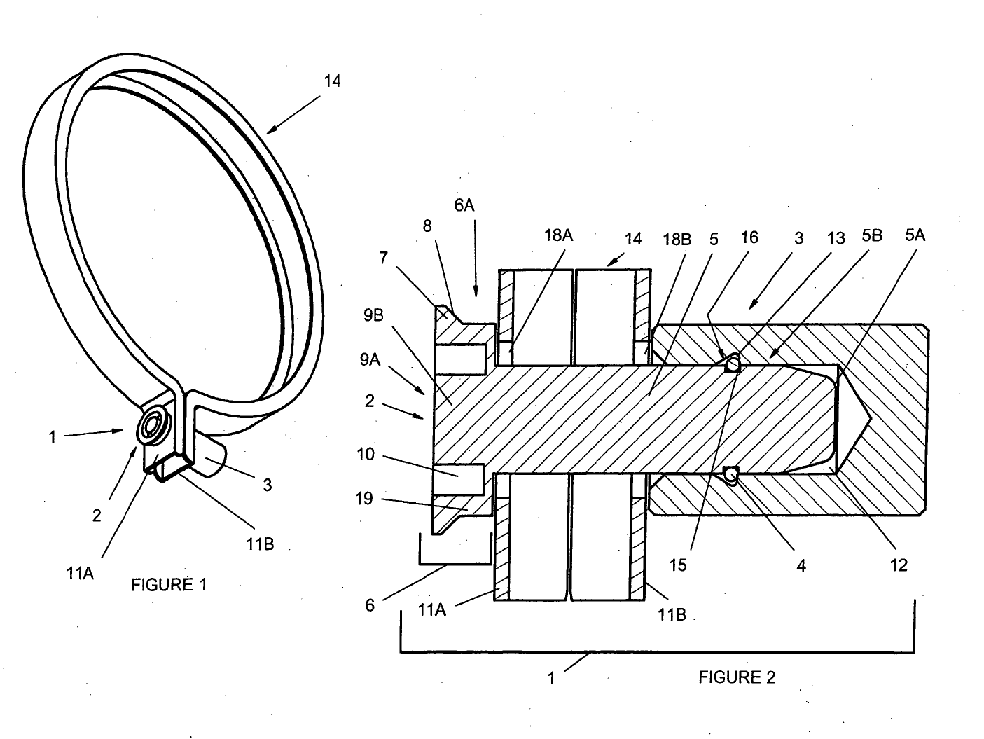

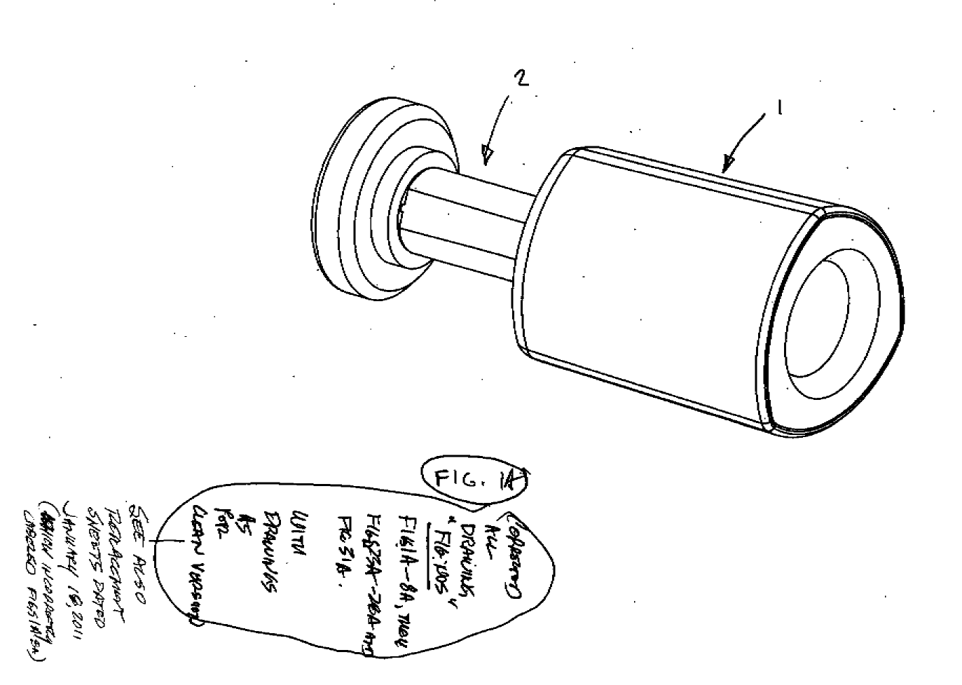

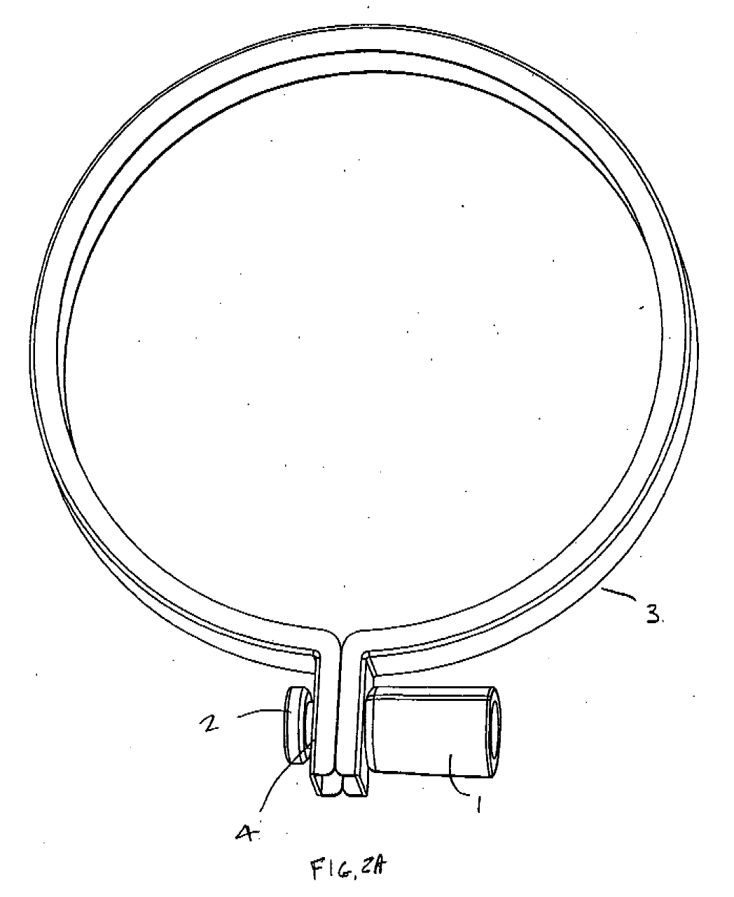

Now referring to FIG. 2, there is shown one example embodiment for creating a tamper-evident seal by securably connecting a plurality of structures with each of the plurality of structures defining an aperture therein. FIG. 2 shows a plurality of structures 11A, 11B having apertures 18A, 18B which may be any of a variety of structures. In one example embodiment, the plurality of structures comprise first and second ends 11A, 11B of a ring 14, which may he connected or disconnected, the ring being adapted to mount a meter to a meter box structure (not shown). Each of the first and second ends 11A, 11B of the ring 14 define apertures 18A, 18B therein respectively.

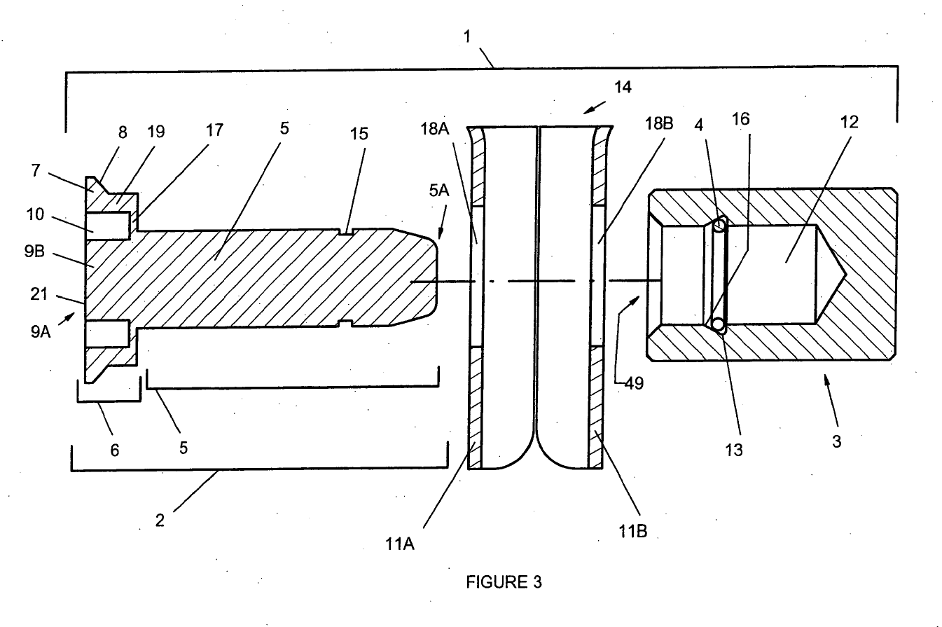

Referring now to FIGS. 1-3, there is shown a locking pin 2 with the locking pin having a distal end 5A insertable through each of the apertures 18A, 18B of the plurality of structures. In the embodiment shown in FIG. 3, the distal end 5A is adapted to be insertable through each of the apertures 18A, 18B of the first and second ends 11A, 11B of the ring 14. The locking pin 2 comprises a head member 6 having at least an engageable end 9A and a fracturable member 17. The locking pin 2 further comprises a shaft portion 5 having the distal end 5A. In the embodiment of FIG. 3, the fracturable member 17 is disposed intermediate the engageable end 9A and the distal end 5A of the locking pin 2. However, the fracturable member may also be disposed so as to be formed integrally with the engageable end of the head member. It should be noted that the fracturable member may also he a frangible or breakable member or any other structure having like characteristics.

As shown in FIGS. 2-3, a lock housing 3 is adapted to retain at least a part 5B of the shaft portion 5, with the plurality of structures or first and second ends 11A, 11B being securably connected between the head member 6 of the locking pin 2 and the lock housing 3.

In one example embodiment, the lock housing 3 preferably has a longitudinal bore therein defining an opening 49 in communication with a cavity 12. The lock housing further comprises a retaining member 4 disposed within a cylindrical groove 13. The cylindrical groove 13 ideally incorporates a sloped surface 16.

As the shaft portion 5 of the locking pin 2 is inserted through the apertures 18A, 18B of sealing ring 14, and then into the opening 12 of the lock housing 3, the shaft cylindrical groove 15 disposed on the locking shaft portion 5 is adapted to receive the retaining member 4, thus retaining the locking pin 2 to the lock housing 3; this is the “locked” position. The flanges 11 of the sealing ring 14 are captivated between the head member 6 of locking pin 2 and the lock housing 3. In one example embodiment, the locking pin 2 is permanently affixed to the lock housing 3.

In another example embodiment, shown in FIG. 15, a retaining pin 11D comprising a shaft portion 55 and a head portion 57, is inserted through apertures disposed in flanges 11C, 11D. An aperture 18C is disposed in shaft portion 55 in a generally perpendicular configuration. When the locking pin 2A and the lock housing 3A are installed through the aperture 18C, the flanges 11C, 11D are captivated between the head portion 57 and the installed locking pin assembly 2A,3A. In this embodiment, the number of flanges to be captivated are not limited to two. The retaining pin 11D and the locking pin assembly 2A,3A may be installed in a single flange, or multiple flanges, depending on the application.

Once in the “locked” position, as shown in FIG. 2, if an attempt is made to separate the locking pin 2 from the lock housing 3, the sloped surface 16 urges the retaining member 4 in a radial direction toward the shaft cylindrical groove 15; this ensures constant retaining member 4 engagement with the shaft cylindrical groove 15, preventing the separation of the locking pin 2 from the lock housing 3.

It should be appreciated, that shaft portion 5, or at least a part thereof, as shown in FIG. 2 may be retained or engaged with the lock housing 3, for example, by hand without the use of a tool.

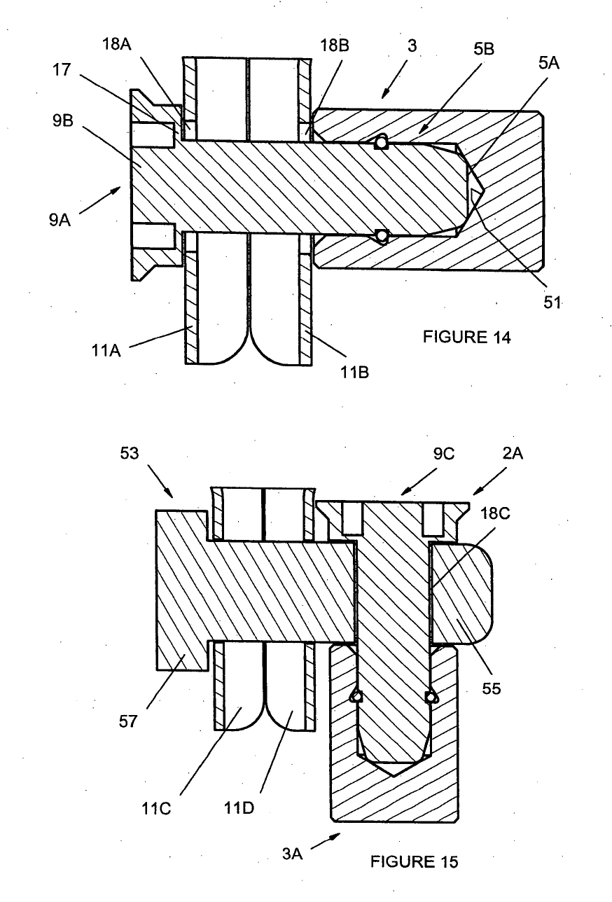

In another example embodiment shown in FIG. 14, lock housing cavity has an end wall 51 selectively displaced from the cavity opening such that the distal end 5A of the shaft portion 5 bears against the end wall when any undesired generally translational force is transmitted to the engageable end 9A; such a configuration helps prevent an undesired force from being transmitted to the fracturable member 17 and possibly breaking it to defeat the locking apparatus. That is, the lock housing 3 is in functional cooperation with at least a part 5B of the shaft portion 5 such that the distal end 5A of the shaft portion is adapted to bear against the lock housing 3. In this way, the lock housing 3, rather than the fracturable member 17, receives any undesired generally translational force transmitted through the engageable end 9A so as to prevent unintended breaking of the fracturable member.

Referring now to FIGS. 2-4, at least a portion of head member 6 has an outer surface 8, 21 adapted to receive at least two opposing forces being of sufficient magnitude to break the fracturable member 17. At least a portion of outer surface 8 of the head member is preferably an angled surface. In certain embodiments, a portion of the head member 6 or outer surface 8, is adapted to receive a first force and the engageable end 9A is adapted to receive a second force with the second force opposing the first force. The first and second forces are preferably applied by a complementary tool described in further detail hereinafter. The first and second forces are of sufficient magnitude to break the fracturable member 17. That is, the head member 6 is adapted to receive a resultant generally axial force against the outer surface 8, 21 of the head member such that the resultant generally axial force is of sufficient magnitude to break the fracturable member so that a part 38 of the head member comprising the fracturable member 17 may be pulled away from the engageable end 9A. In this way, the part 38 of the head member with the fracturable member 17 is adapted to separate from the engageable end 9A and the shaft portion 5 such that the plurality of structures or ring ends 11A, 11B may be disconnected.

It will be appreciated that the angular surface 8 prevents a common prying or pulling device such as a “gear puller” from gripping the engaging flange 7 in an attempt remove the ring portion 19 from the shaft portion 5.

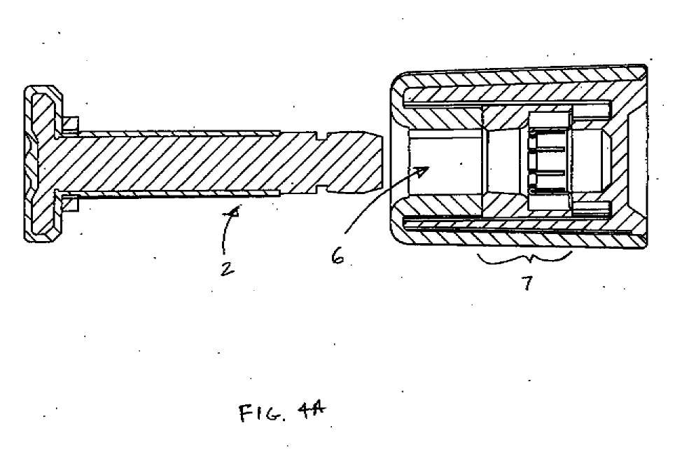

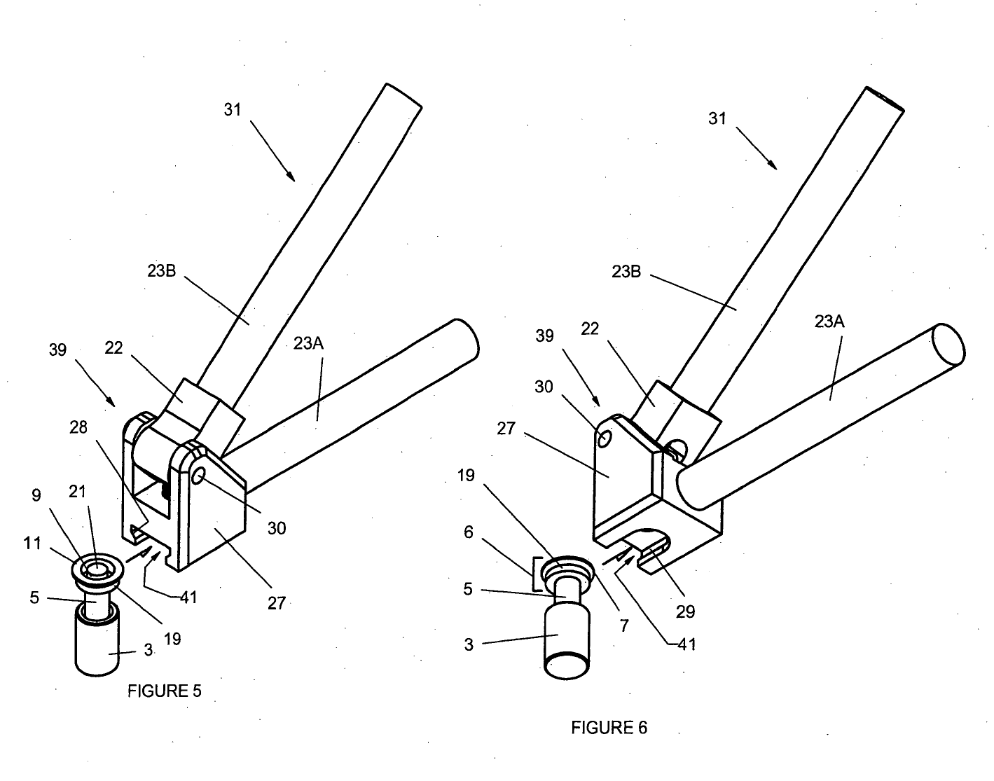

Turning now to FIGS. 5-6, an example embodiment of the invention is shown, comprising a complementary tool 31, or lock assembly removal tool, which is adapted to manipulate the head member 6 outer surface to break the fracturable member 17. The complementary tool 31 comprises, an actuator housing 39 defining an encapsulating cavity 29 having an interior surface 41 adapted to capture the head member 6. The outer surface 8, 21 of the head member 6 is configured so as to be complementary to the interior surface 41 of the encapsulating cavity 29.

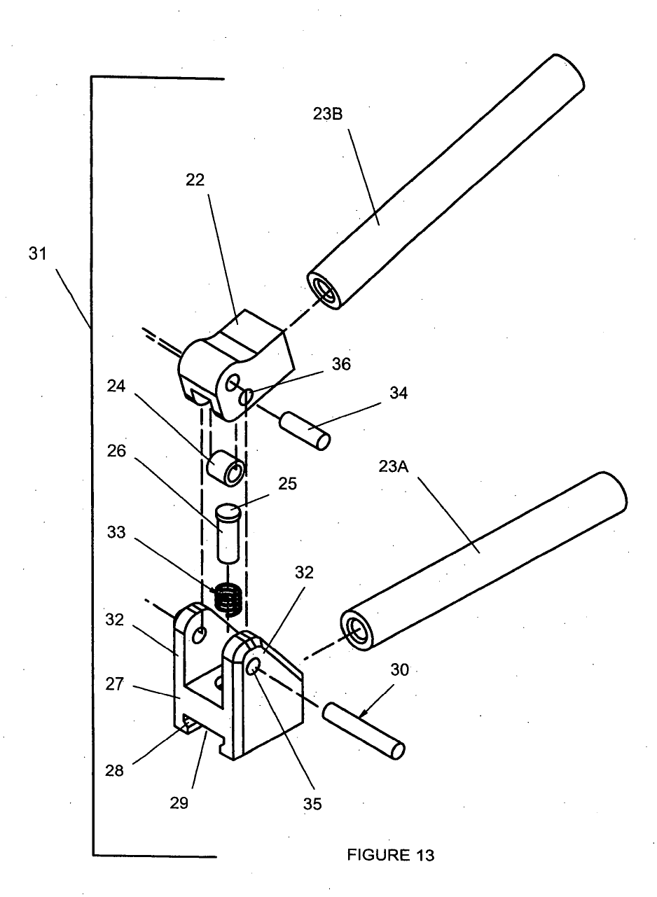

Referring to FIGS. 5-10, and 13, in one example embodiment, the complementary tool 31 is comprised of first and second actuating handles 23A, 23B, a base member 27, a pivoting member 22, two pivot pins 30, 34, an actuating pin 26A, a force-exerting member 24., and a spring member 33. The actuating handles 23A, 238 are securely fastened to the base member 27, and the pivoting member 22. The base member 27 and the pivoting member 22 are preferably joined and rotatably communicate through a common fulcrum defined by apertures 35 and 37, and pivot pin 30 (as shown in FIG. 13). A pin 34 passes through the force-exerting member 24, and the opposing apertures 35 disposed on the pivoting member 22. This captivates the force-exerting member 24 between two flanges on the pivoting member 22, allowing the force-exerting member 24 to pivot. The first handle 23B may be mounted such that it freely rotates or is frictionally pivotable or rotational.

The first handle 23A is preferably fixedly connected to the actuator housing 39 and the second handle 23B is pivotably connected to the actuator housing. Both the first and second handles 23A, 23B could also be detachably mounted to the actuator housing to foster ease of storage and the like.

The second handle 23B is preferably in functional cooperation with the actuator housing 39 with the actuator housing adapted to capture the head member 6 and to bear against the engageable end 9A to break the fracturable member 17 when the second handle is actuated. In an example embodiment, the second handle 23B is preferably adapted to be pivoted away from the first handle 23A to an open configuration or position. In the open configuration, the actuator housing 39 is adapted to capture the head member 6. Then, in response to a force applied to the second handle 23B, the second handle 23B is adapted to pivot toward the first handle 23A to a closed configuration or position. In the closed configuration, the actuator housing 39 is adapted, as mentioned above, to in general, axially bear against the engageable end 9A so as to break the fracturable member 17.

With such a configuration, complementary tool 31 is usable with one hand to manipulate the head member 6.

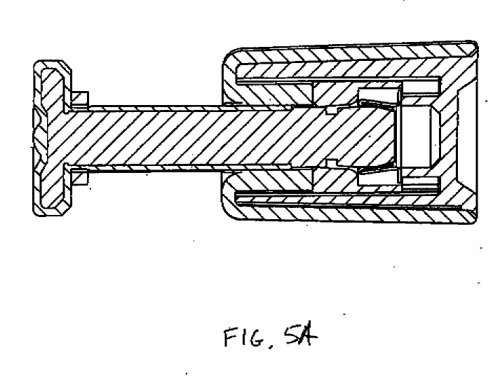

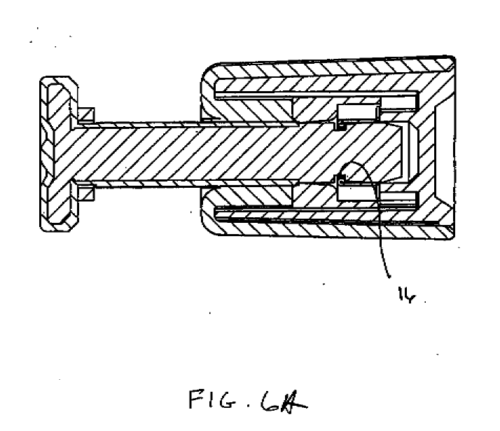

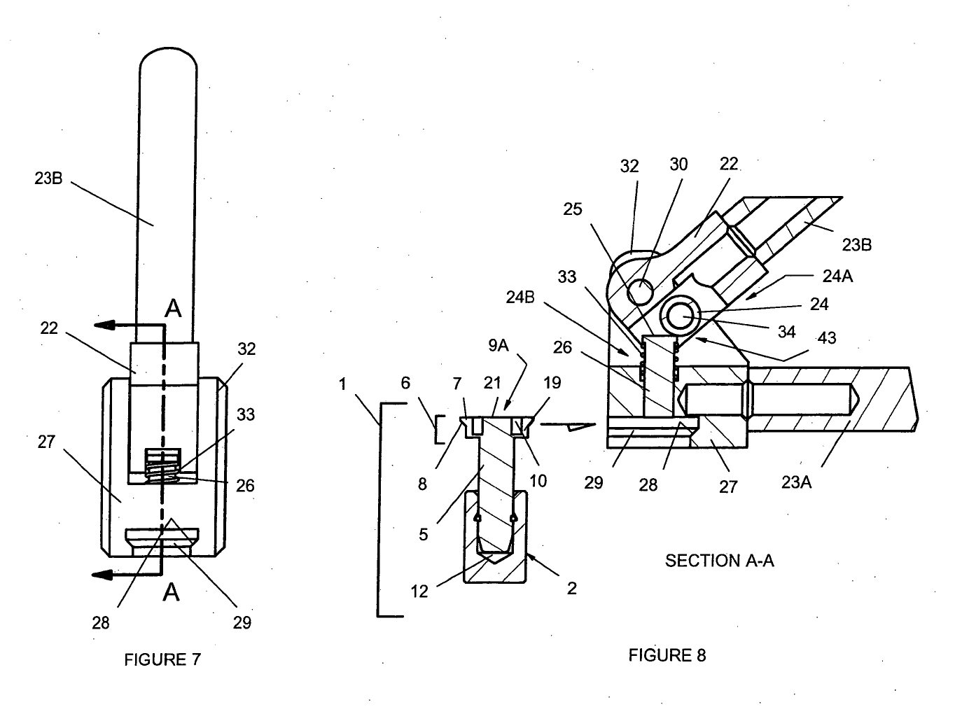

Turning in particular to FIGS. 7-10, in certain embodiments, the actuator housing 39 comprises a force-exerting structure 43 adapted to convert a pivoting rotational force to a generally translational force so as to in general, axially bear against the engageable end with the force being of sufficient magnitude to break the fracturable member 17. In an example embodiment as shown in FIG. 8, the force-exerting structure 43 comprises a force-exerting member 24 and a force-responsive member 26. In one example embodiment, the force-exerting member 24 is a cam-like structure or cylinder and the force-responsive member 26 is an actuating pin.

The force-exerting member 24 is preferably adapted to be carried along a curved path and simultaneously rotate or roll during engagement with a surface 25 of the force-responsive member 26 when the second handle 23B is pivoted towards the closed configuration. The force-responsive member 24B is adapted for generally translational movement during engagement by the force-exerting member 24 so as to transmit a resultant generally translational force to the engageable end 9A.

It should be noted that, in response to a force applied to the first and second handles 23A, 23B, the first and second handles and actuator housing 39 are cooperatively adapted to transmit a mechanically multiplied generally translational force to the engageable end 9A. With such a configuration, the force is of sufficient magnitude to break the fracturable member 17.

In view of the above configuration, it will be appreciated that, the head member 6 is adapted to be manipulated by selectively bearing only against the head member rather than the head member and another structure, such as for example, one of the rings 11A, 11B or the lock housing 3.

The head member 6 is also adapted such that it may be manipulated from only one side of the rings 11A, 11B or other plurality of structures connected or held together.

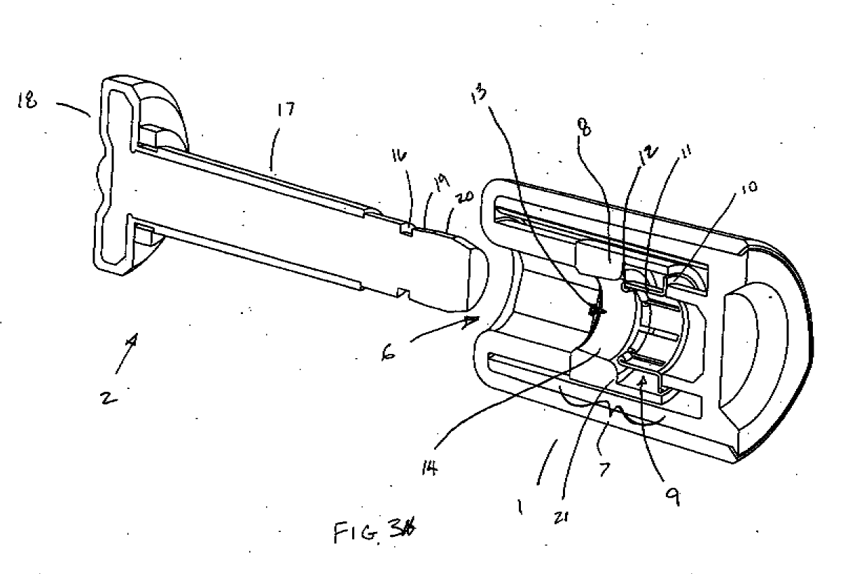

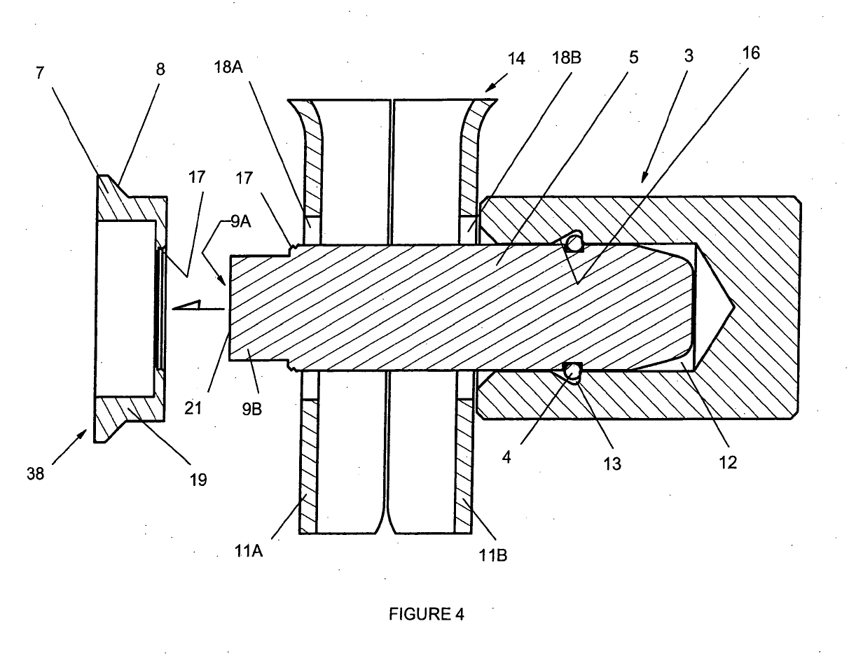

Referring again to FIG. 4, after manipulating the head member 6 and breaking the fracturable member 17, the encapsulating cavity 29 of the actuator housing 39 is adapted to securely confine the remaining part 38 of the head member 6. In this way, the head member can be captured or held within the tool after using the tool to manipulate the head member.

In an example embodiment, the second handle 23B is frictionally pivotable with respect to the actuator housing 39 so as to prevent unwanted pivoting of the second handle to an open position. With this configuration, the part 38 of the head member 6 is prevented from being inadvertently released after head member is manipulated and the fracturable member 17 is broken.

It will also be appreciated that in another embodiment, the second handle 23B is pivotable to a stowed configuration, with the second handle 23B being substantially aligned with the first handle 23A so as to facilitate storage and handling.

In an alternate embodiment, the complementary tool may comprise the actuator housing without the actuating handles. That is, the actuator housing 39 may have a modular construction and comprise a power source for actuation so as to manipulate the head member. The power source may be electric or some other power source as would be understood by one of skill in the art.

Referring again to in FIGS. 2-4, the head member 6 of locking pin 2 further comprises a structural element 9B adapted to displace a surface 21 of the engageable end 9A away from the fracturable member 17. With such a configuration, structural element 9B serves as an anti-tampering element adapted to distance and protect the fracturable member from the engageable end so as to prevent undesired access to the fracturable member. That is, the material of the structural element would essentially have to he drilled out in order to gain access to and attempt to tamper with fracturable member to break it.

In one example embodiment, the structural element 9B comprises a cylindrical standoff member adapted to displace the engageable end from the fracturable member by a selected distance so as to prevent tampering with the fracturable member. In another embodiment, at least a portion of the head member is hardened to further deter attempts to defeat the locking assembly.

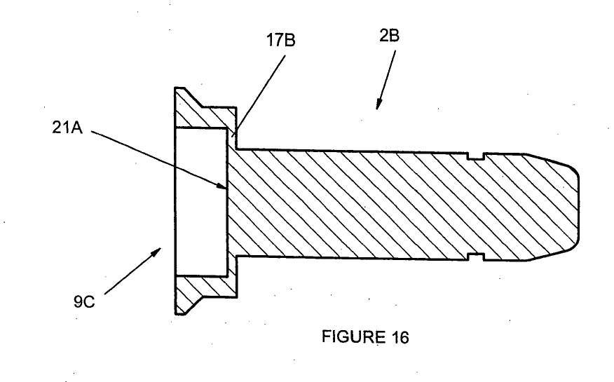

In other embodiments, however, the surface 21A of the engageable end 9C could be integrally formed with and lie substantially in the same plane as that defined by the fracturable member 17B, as shown in FIG. 16 For example, in an example embodiment, the engageable end could be formed with the fracturable 17B such that there is only a part of or no head section 6A.

In another embodiment, the fracturable member is disposed immediately adjacent at least one of the plurality of structures. Such a configuration helps to minimize access to and deter tampering with the fracturable member 17.

Turning again to FIG. 2, in one embodiment, the head member 6 has at least an engageable end 9A and fracturable member 17. The head member may also comprise a head section 6A having at one end the engageable end 9A, and fracturable member 17. The head section 6A preferably comprises a ring portion 19 which has a flanged portion 7 having an angular surface 8, and structural element 9B (or a cylindrical portion) which serves as a force-bearing portion with one end as the engageable end 9A. The structural element 98 is preferably disposed within the ring portion 19 so as to define a circumferentially extending channel 10 therebetween. In one embodiment, the fracturable member is interposed between the shaft portion 5 and a head section 6A. However, in other embodiments, the fracturable member may be interposed at different positions. In certain example embodiments, the fracturable member is interposed between the shaft portion and engageable end or disposed at the engageable end.

In one example embodiment, the locking apparatus creates a tamper-evident seal by securably connecting a plurality of structures, such as for example, ring ends 11A, 11B. Each of the ring ends preferably defines an aperture 18A, 18B therein. The locking pin is insertable into each of the apertures 18A, 18B and preferably comprises a shaft portion, a fracturable member, and a head section having an engageable end. The lock housing is adapted to retain at least a part of the shaft portion, with the ring ends connected between a portion of the locking pin and the lock housing. The head section has a structural configuration adapted to receive at least two opposing forces being of sufficient magnitude to break the fracturable member.

In use, as shown in the example embodiment of FIGS. 5-8, and 13, the encapsulating cavity 29 disposed on the base member 27 of the complementary tool, or lock removal tool 31, is adapted to receive the head member 6 of the locking pin 2. As the handles 23 are urged apart, the base member 27 and the pivoting member 22 of the lock removal tool 31 are pivoted about the pivot pin 30. The force-exerting member 24 is urged away from the actuating pin 26. The spring member 33 urges the actuating pin 26 toward the force-exerting member 24, allowing the head portion 6 of the locking pin 2 to freely enter the encapsulating cavity 29.

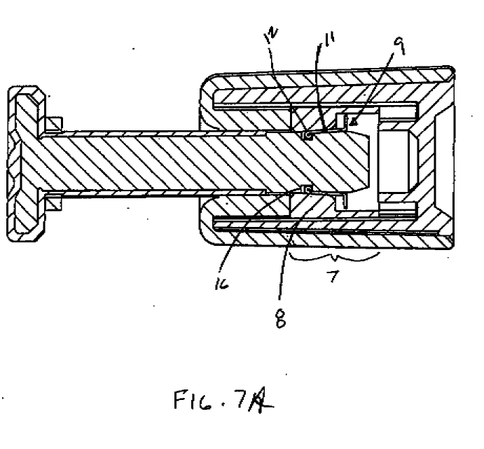

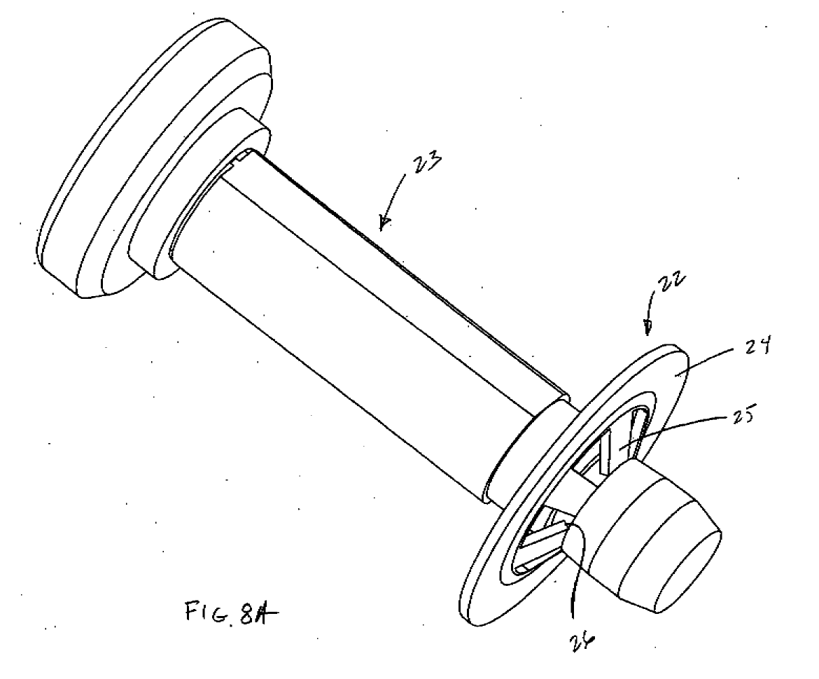

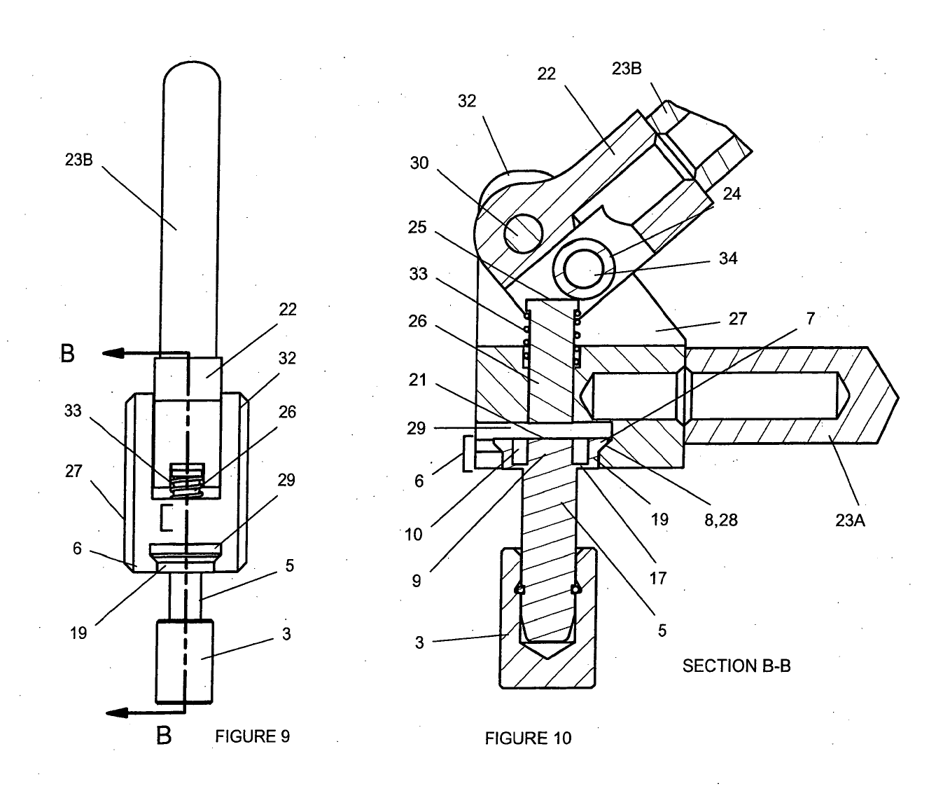

As shown in FIGS. 9 and 10, the head member 6 is inserted into the encapsulating cavity 29. An angular surface 28 disposed on base member 27 is adapted to securely retain the engaging flange 7 disposed on ring portion 19 of the head member 6.

As the handles 23A, 23B are urged together, the base member 27 and the pivoting member 22 of the lock removal tool 31 are pivoted about the pivot pin 30. The force-exerting member 24 is urged toward and bears on the surface 25 of actuating pin 26. As briefly mentioned above, the force applied to the actuating handles 23A, 23B is preferably mechanically multiplied and translated to the surface 21 of the structural element or cylindrical portion 9 of the head member 6. When the force applied to the surface 21 of the cylindrical portion 9 by the actuating pin 26 is greater than the ultimate strength of the fracturable portion 17, the ring portion 19 will separate from the remainder of the shaft portion 5, allowing the removal of the remainder of the lock assembly from the sealing ring 14.

Various other example embodiments provide an apparatus that may be adapted for use on a utility service enclosure. Such a utility service enclosure is used not only in the electric utility industry (e.g., a meter box) but also in the gas, water, cable, TV utility industries or in other utility industries.

In another embodiment an apparatus is provided for creating a seal. A locking pin is adapted to unite a plurality of structures. One example of such structures would be the ends of meter ring having apertures 18A and 18B as shown in FIGS. 1 and 2. However, the locking pin could also be configured to be used to unite a plurality of plates having apertures, engageable protrusions, or other engageable structural configurations such that the plates could be united with a fracturable locking pin of various configurations. A lock housing is adapted to retain at least a part of the fracturable locking pin such that the plurality of structures would be secureable between a portion of the fracturable locking pin and at least a portion of the lock housing. The portion of the fracturable locking pin is also adapted to receive direct application of opposing forces by a separate object, whereby the fracturable locking pin (such as in one example embodiment shown in FIG. 1) may be fractured.

In another example embodiment a stress-concentration member is adapted to concentrate stress at a desired location on the locking pin. An example of a stress-concentration member may be the fracturable member 17 as shown in FIG. 3.

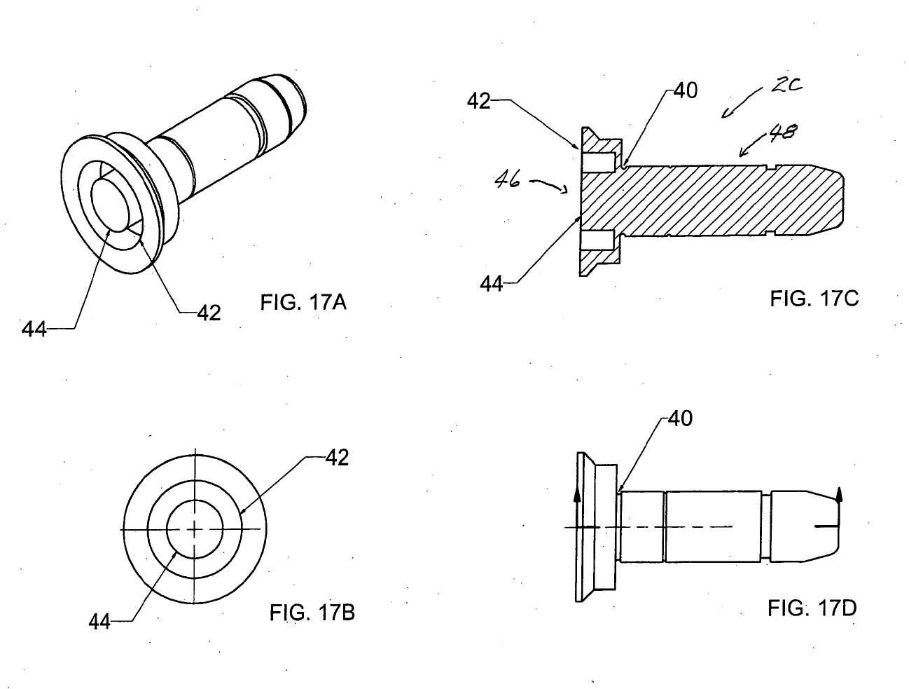

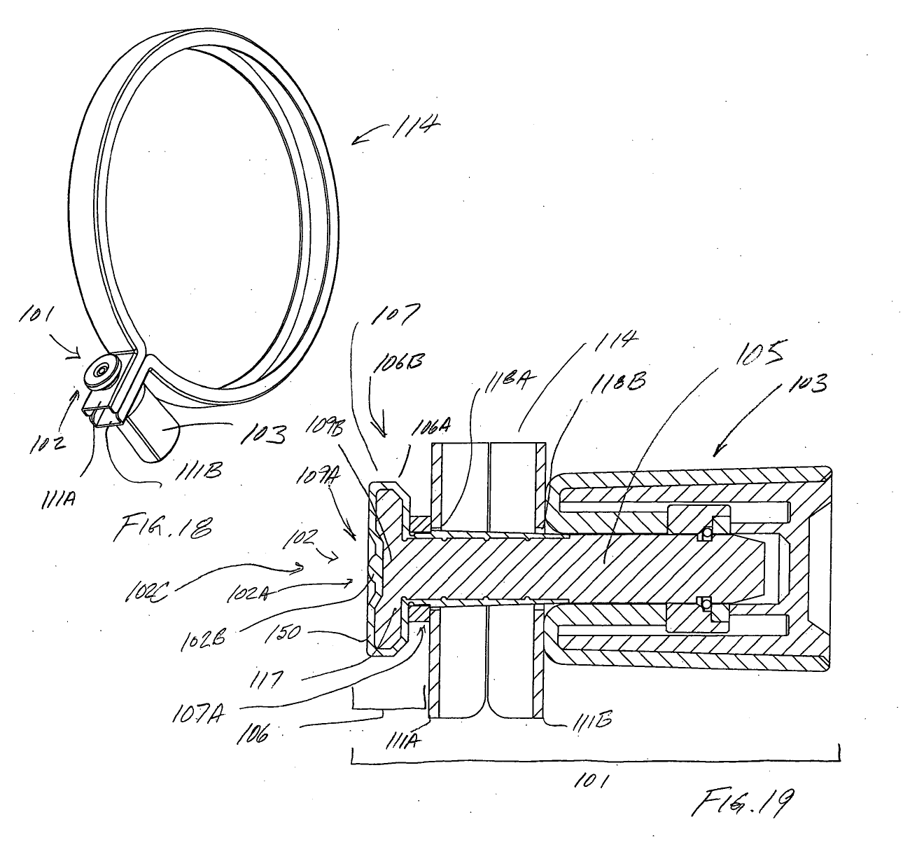

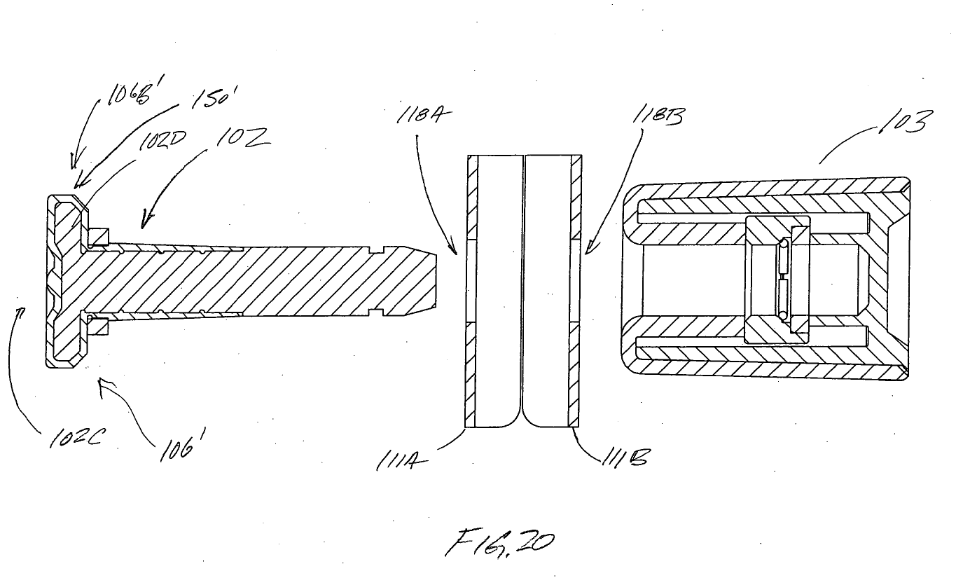

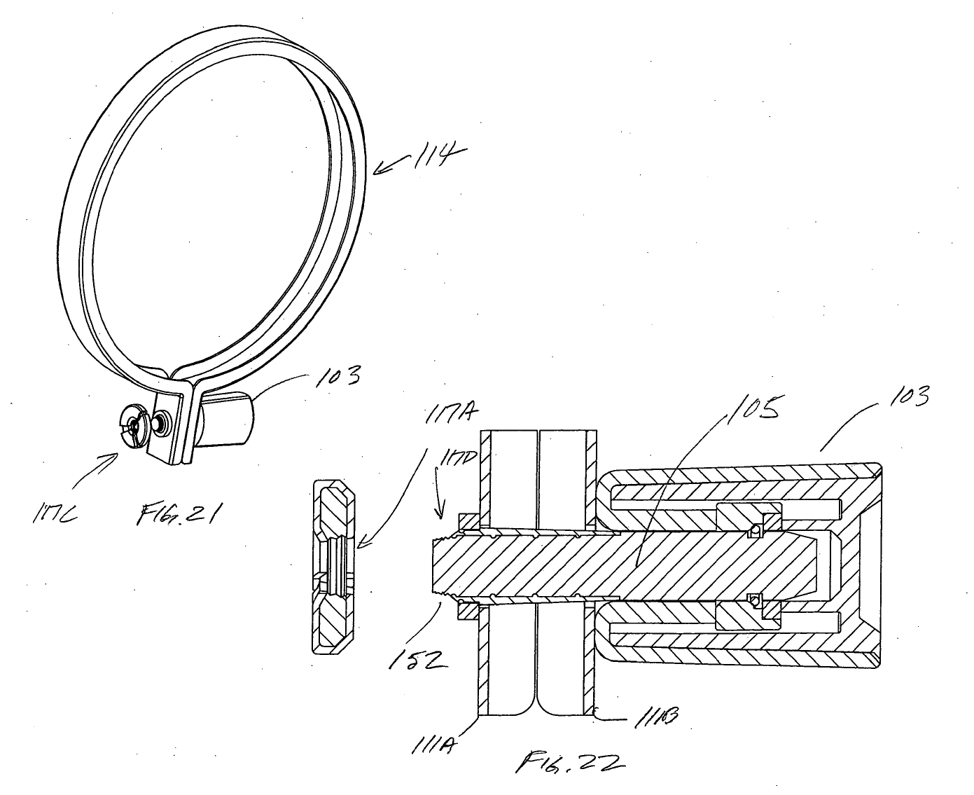

In another example embodiment a further stress-concentration member is also adapted to concentrate stress at a desired location on the fracturable locking pin. In this way, the fracturable locking pin may be fractured with a desired fracture configuration. As shown in FIGS. 17A-17D, the fracturable locking pin 2C further comprises a shaft portion 46, 48, and wherein the further stress-concentration member comprises a groove 40 formed in at least a portion of the shaft portion. In one example embodiment, the further stress-concentration member comprises a groove formed in the shaft portion 46, 48. In another example embodiment, the further stress-concentration member comprises an annular groove 40 formed in the shaft portion. Ideally, the fracturable locking pin comprises first and second shaft sections 46, 48, a fracturable member (in one embodiment, e.g., 17) disposed between the first and second shaft sections, and a head section. The further stress-concentration member is adapted to concentrate stress on the fracturable member in a region within a projected area of the second shaft section 48. In one embodiment this may be in a region within a projected area of the diameter of the second shaft section 48. The further stress-concentration member to concentrate stress on the fracturable member is preferably in functional cooperation with the relative diameters of the first and second shaft sections 46, 48.

In other words, this further stress-concentration member favorably affects the broken burr left after the fracturable member is broken (e.g., see FIG. 4) and may foster clearance of the broken shaft through the aperture 18A. The stress-concentrating features allow control over breakable region along shaft. This may also be viewed as intermediate-recess along the shaft or shaft diameter-reduction feature. In an example embodiment, the first shaft section outside diameter is in cooperation with the fracturable member outside diameter which is in turn in cooperation with the intermediate cooperative recess with provides fracture-configuration (or configurable-fracture) features for controlling the configuration, shape and size of the breakage of the fractureable member with respect to the shaft. Fracturable member is preferably disposed intermediate the ends of the locking pin; the reduced diameter is preferably immediately adjacent the fracturable member so as to foster controlling the location of fracture by creating a locally reduced shaft diameter.

In another embodiment, a fracture-configuration-control member is adapted to control the configuration of fracture of the fracturable locking pin. In one embodiment this is the further stress-concentration member may be configured for controlling the characteristic of the fracture.

In another embodiment, the portion of the fracturable locking pin 2C comprises a head member 42 disposed substantially near an outer side of one of the plurality of structures (not shown). The portion of the fracturable locking pin in another embodiment preferably comprises a head section and an engageable end near (e.g., 44 in FIG. 17A).

Various other example embodiments provide an apparatus or tamper-evident seal that may be adapted for use on a utility service enclosure, transportation or cargo containers or on other enclosures needing a tamper-evident seal and locking apparatus. Moreover, a utility service enclosure or other containers, for example, may have various configurations, shapes and sizes and be used in the electric utility industry, (e.g., a meter box) as well as in the gas, water, cable, TV utility industries or in the shipping or transportation industries.

Turning now to FIGS. 18 and 19, another example embodiment is provided which includes tamper-evident features. A seal 101 comprises a fracturable locking pin 102 which is adapted to unite a plurality of structures. One example of such structures would be the ends of meter ring having apertures 118A and 118B as shown in FIGS. 18 and 19. However, the locking pin could also be configured to he used to unite a plurality of structures, used with a utility service enclosure, or for example used to seal or create a tamper-evident seal to indicate tampering with, for example, utility enclosures doors, lids or other secured panels, meter boxes, or trucking, shipping, airline or other transportation or cargo containers or other enclosures. The plurality could include plates having apertures, engageable protrusions, or other engageable structural configurations such that the plates could be united with a fracturable locking pin of various configurations adapted to fit security enclosures used various industries.

As shown in FIGS. 18 and 19, the seal 101 further comprises a housing 103 adapted to retain at least a part of the fracturable locking pin 102. In one embodiment, a plurality of structures 111A and 111B is secureable between a portion 106B of the fracturable locking pin 102 and the housing 103. To release the plurality of structures, the portion 106B of the fracturable locking pin is adapted to receive direct application of opposing forces by a separate object, whereby the fracturable locking pin may be fractured. For example, in one embodiment, the separate object may be a tool adapted to fracture the fracturable locking pin. In other embodiments, the fracturable locking pin may have a fracturable portion configured such that it may be fractured by hand (e.g., without the use of a tool or the like).

The seal 101 as illustrated in FIGS. 18-19, 21-22, seal 101 further comprises an indication member 150 adapted to reveal evidence 117A-117D of any application of force to the indication member.

In another example embodiment of the seal, the indication member 150 comprises a coating adapted to encapsulate at least some of the fracturable locking pin 102. The fracturable locking pin 102 is preferably at least partially surrounded with the indication member 150.

Another example embodiment of the seal includes an indication member 150 which further comprises a stress-propagation member 102A, as shown in FIG. 19 adapted to selectively propagate any stress resulting from application of force to the indication member. In this way, evidence of any application of force to the indication member may be more dearly revealed. In one embodiment, the stress-propagation member further comprises a protuberance 102B disposed on the portion 106B of the fracturable locking pin.

As shown in FIGS. 18-20, in an example embodiment, the portion of the fracturable locking pin comprises a head member 106 having a central region 102C; the protuberance may, for example, being integrally formed with the indication member and disposed proximate the central region.

In another example embodiment of the seal, the portion 106B′ shown in FIG. 20 of the fracturable locking pin further comprises a head member stress-concentration element 102D disposed in functional cooperation with the indication element 150′ to impede propagation of any stress resulting from application of force to the indication member 150′, wherein evidence of any application of force to the indication member disposed proximate the portion of the fracturable locking pin 102′ may be more clearly revealed. In an example embodiment, the portion of the fracturable locking pin further comprises a head member stress-concentration element integrally disposed in functional cooperation with the indication member.

Another example embodiment provides the portion of the fracturable locking pin comprises a head member having a central region 102C. A head member stress-concentration element 102D is ideally configured to concentrate, or in another embodiment localize, proximate the central region 102C of the head member 106′ any stress resulting from application of opposing forces.

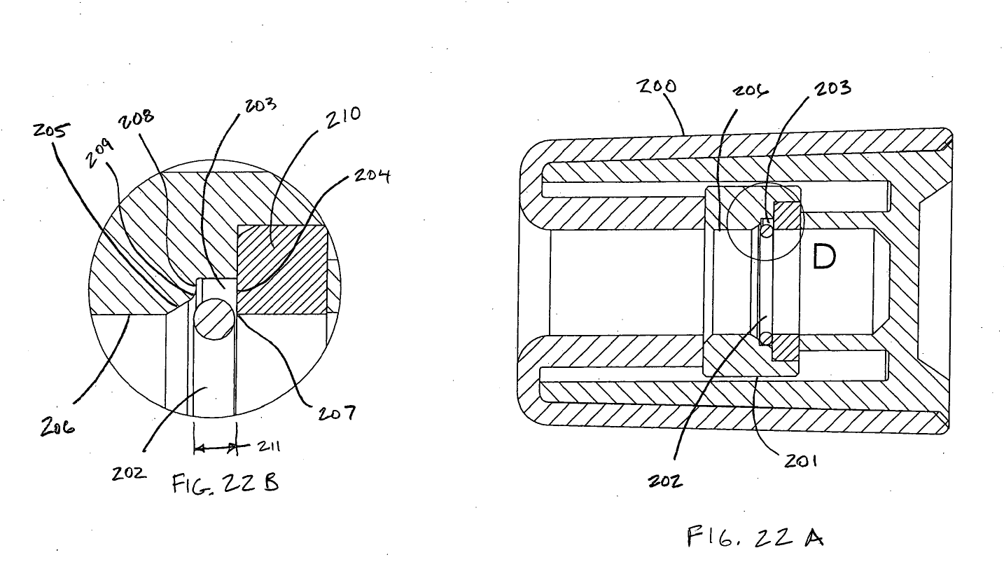

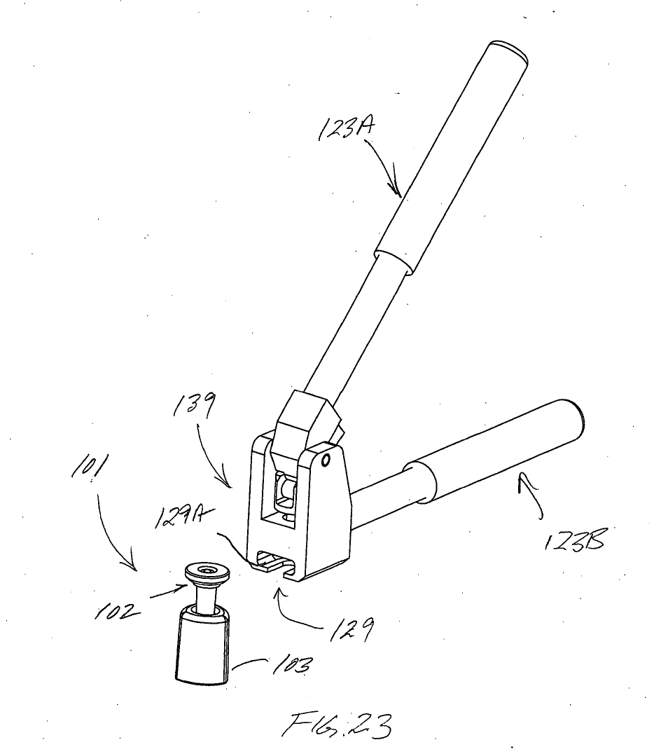

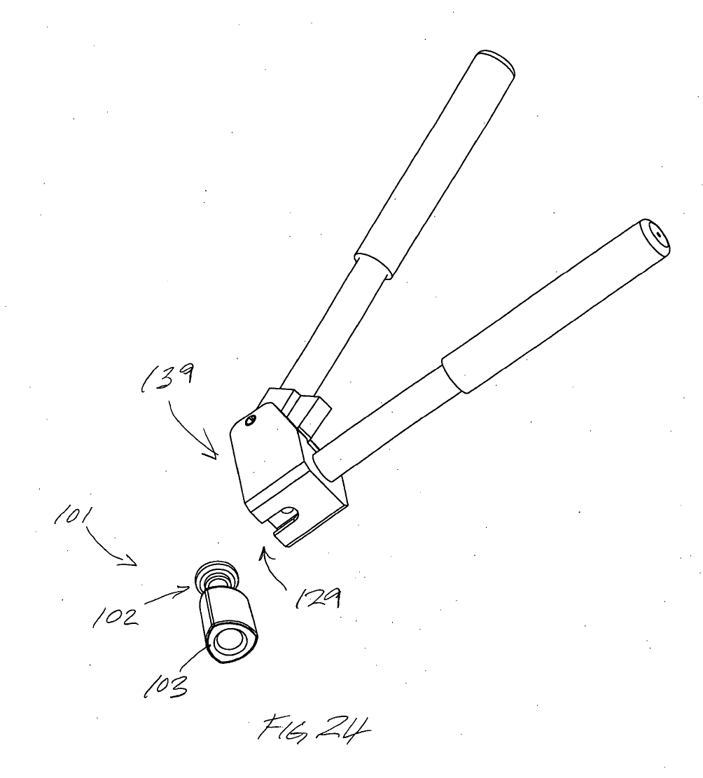

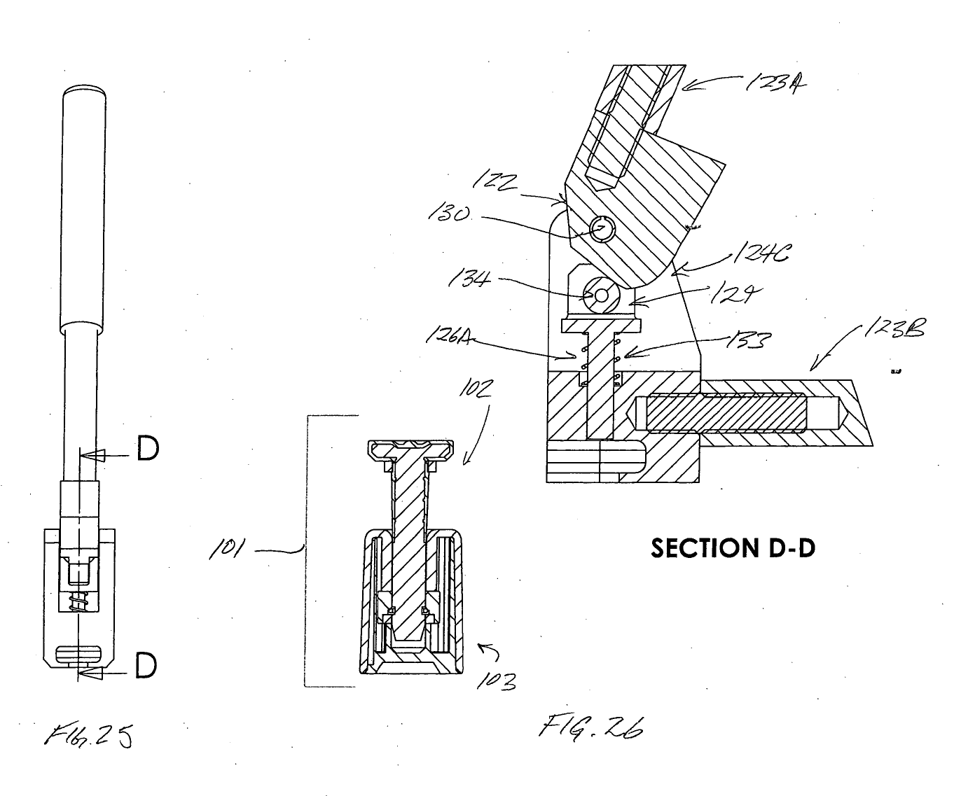

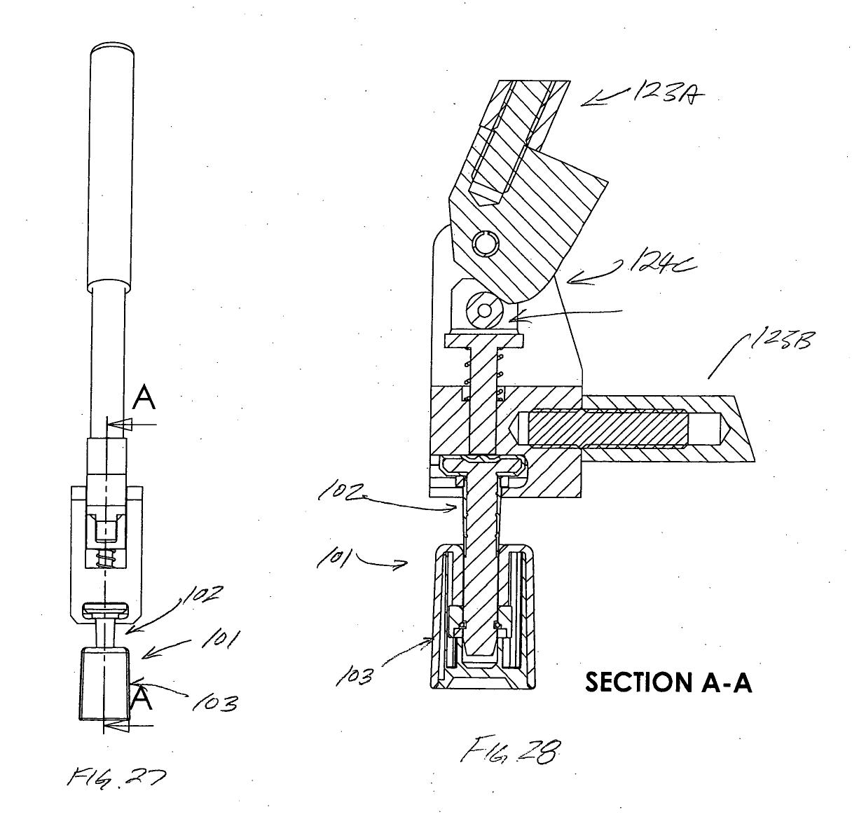

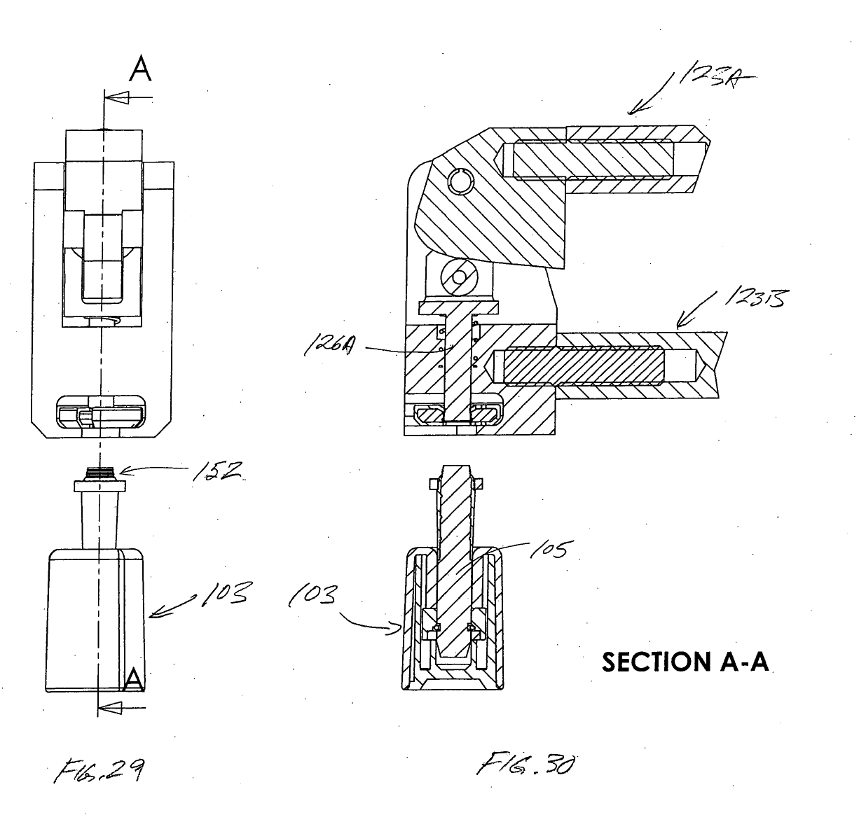

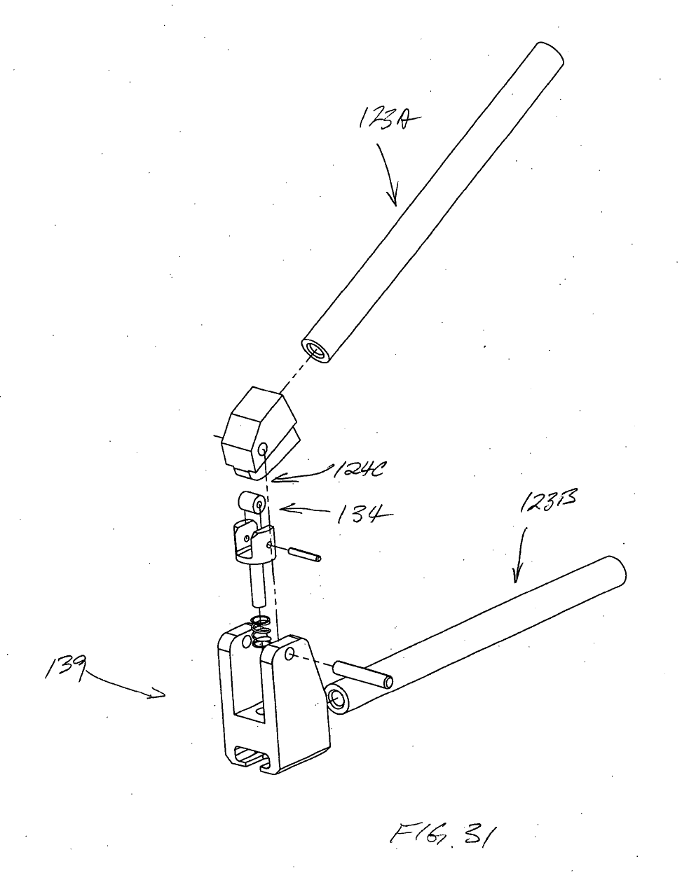

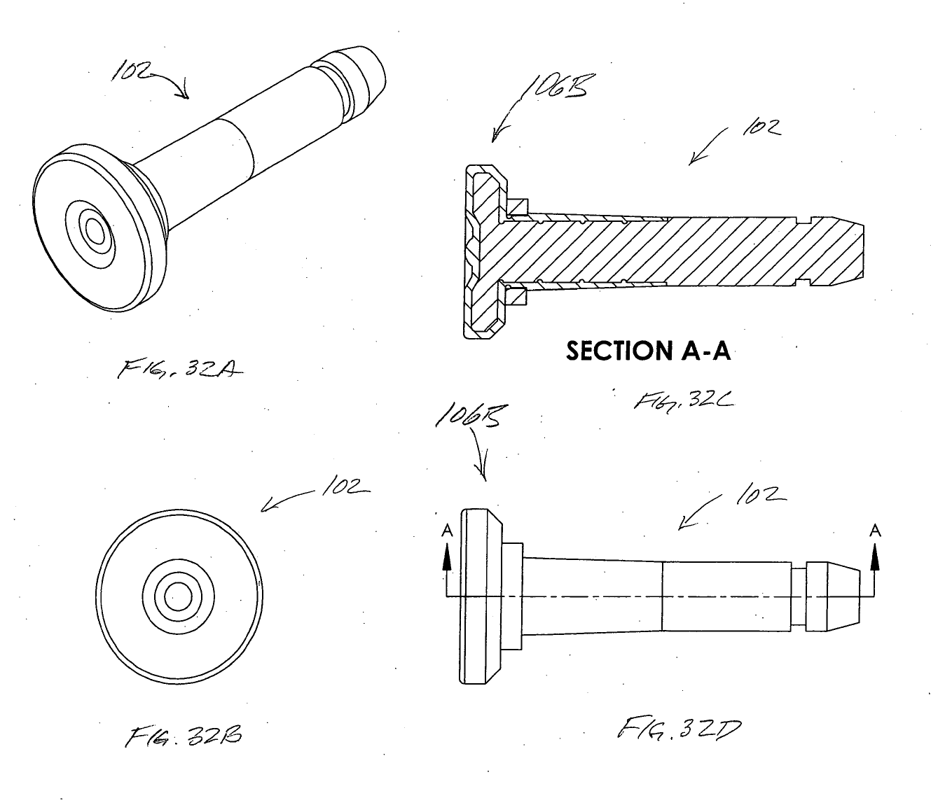

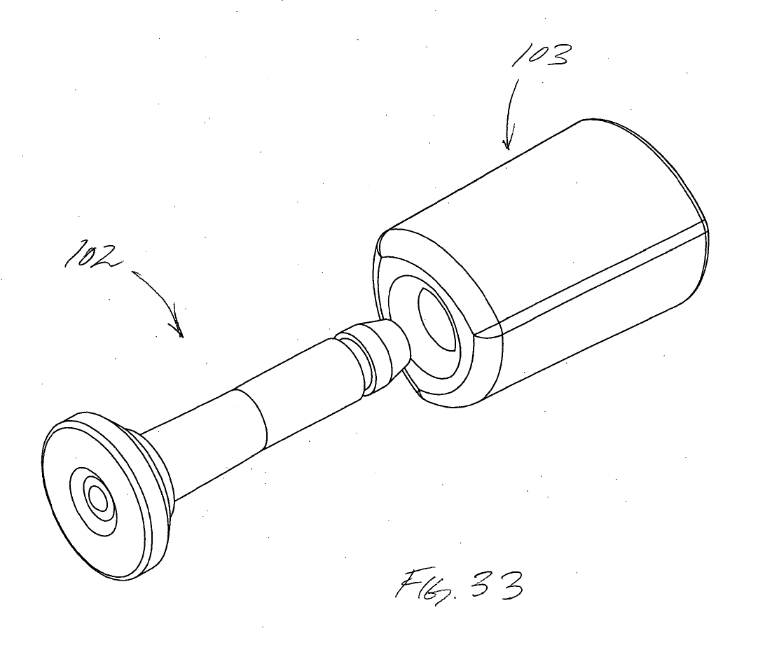

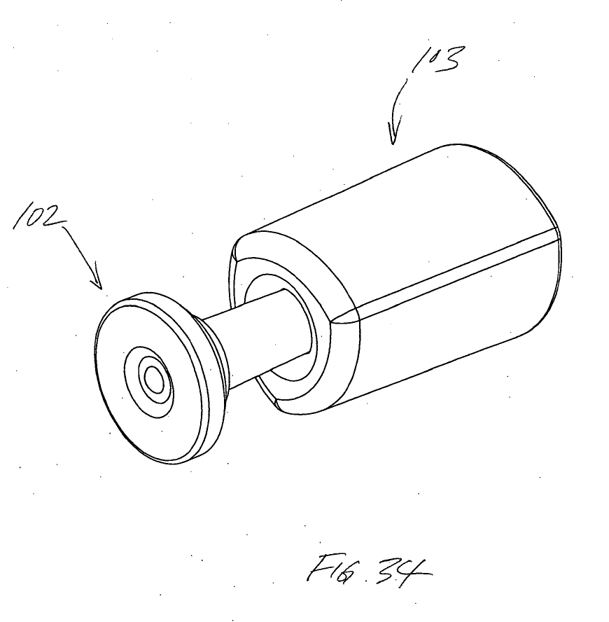

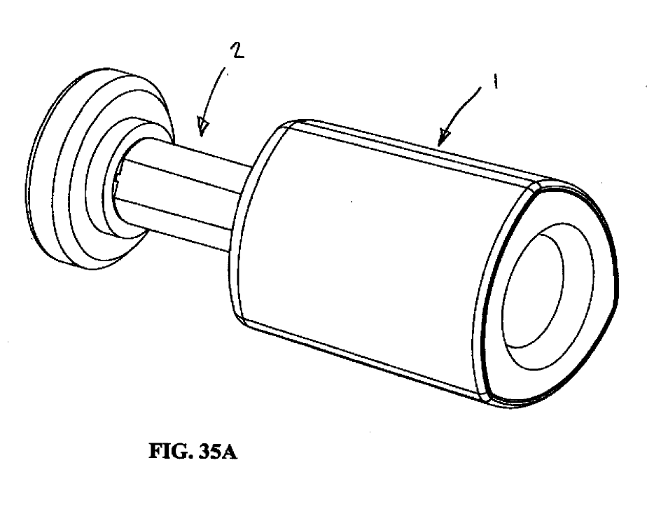

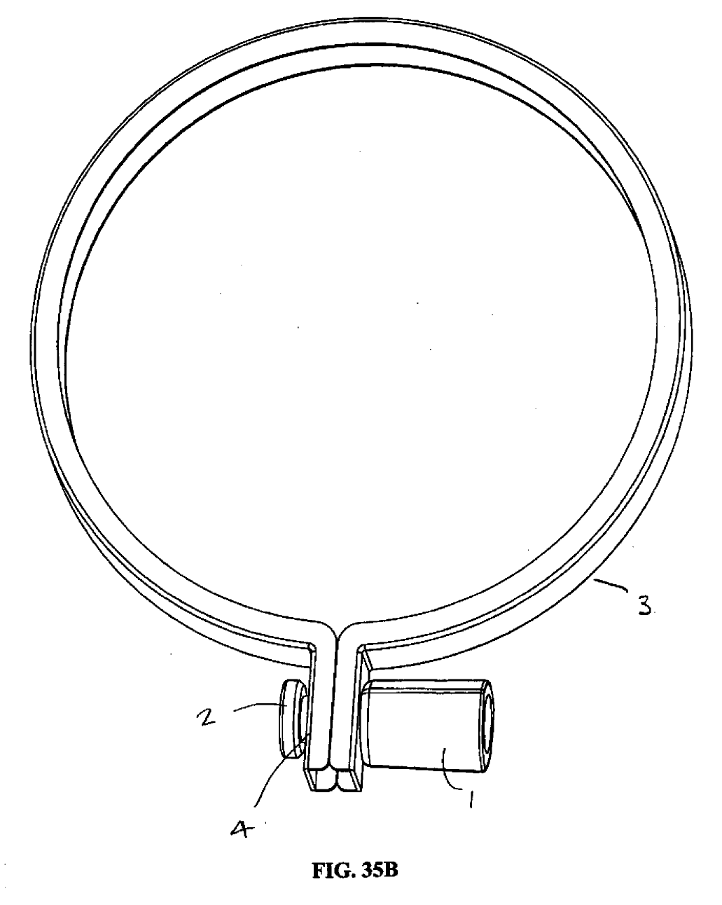

In another example embodiment of the seal, the housing 200 such as shown in FIG. 22A in cross-section, further comprises a retainer 201 having a retaining member 202 and a retaining member recess 203, the retaining member recess adapted to retain the retaining member.

In the example embodiment of the seal shown in FIGS. 22A and 22B, the retaining recess 203 is formed in part by a first wall of the retainer 204, the first wall being in spaced in opposing relation to an inclined wall 205 oriented at an angle with respect to the first wall and a central bore 206 of the retainer 201, and wherein the first wall is in functional cooperation with the inclined wall so as to reduce the clearance between the surface of the inclined wall 205 and the surface of the first wall of the retainer 204 the retaining recess when the retaining member. The retaining member 202 is retained within the retaining recess and the reduced clearance between the inclined wall 205 and the first wall of the retainer 204 act so as to foster hindering access and removal of the retaining member by pick tools. By reducing the amount of free play in the retaining recess the retaining member is hindered from moving sufficiently into the central bore 206 and reduces the amount of exposed surface area of the retaining member that would allow a picking tool to grab the retaining member in a substantial enough manner to allow it to be extracted from the retainer. A prior devices have been known to be vulnerable to removal of the retaining member. The removal of the retaining member could allow a dishonest person to install a seal that would appear to be properly installed but in reality could be removed without showing evidence of entry.

Referring to the detail view of FIG. 22A shown in FIG. 22b, the inclined wall 205 intersects a second surface 208 and is shown with a radius 209 generally at the intersection. This radius assists in camming the retaining member inward if an axial force is applied to a locking pin when it is installed in the recess. The action of an inclined surface with a locking pin in a seal is well known by those skilled in the art. By reducing the intersection point of the inclined surface 205 and the second surface 208 the inclined surface 208 is still able to interact with the retaining member yet limits rotation of the retaining member out of the retaining recess and reduces access to a sufficient portion of the body of the retaining member to allow it to be gasped by a picking tool.

FIGS. 22A and 22B illustrate an embodiment of the invention and provides a width 211 for the retaining recess 203 generally along the axial direction of the central bore 206 of the retainer that is equal to the width of the retaining member along the axial direction of the central bore plus a fraction of the width of the retaining member along the axial direction of the central bore. This along with the reduced clearance between the first wall and the inclined wall act to reduce the free play of the retaining member and thus inhibit its un-authorized removal.

In other embodiments of the invention, a sharp corner, a chamfer or other transitional surface could be used in place of the radius 209 shown in FIG. 22B.

In the embodiment shown in FIGS. 22A and 22B, the first wall 204 of the retainer is part of a retaining member retainer 210. The retaining member retainer in the current embodiment is pressed in place and held in assembly by frictional forces. Other embodiments be held in place using an adhesive, by crimping, staking welding or other suitable means as would be apparent to those skilled in the art of fastening. The retaining member retainer 210 holds the retaining member 202 in place during assembly and provides support for the retaining member 202 after the retainer 201 is installed in the housing 200.

In an example embodiment of the seal, the housing further comprises a retainer having a retaining member and a retaining member recess, the retaining member recess adapted to retain the retaining member.

In another example embodiment of the seal, the retaining recess is formed in part by a first wall of the retainer, the first wall being in spaced in opposing relation to an inclined wall oriented at an angle with respect to the first wall, and wherein the first wall is in functional cooperation with the inclined wall so as to reduce the clearance between the retaining member and the retaining recess when the retaining member is retained within the retaining recess, so as to foster hindering access and removal of the retaining member from retaining recess.

As shown in FIG. 19, the fracturable locking pin 102 further comprises a spacing member 107A adapted to space the portion of the fracturable locking pin 102 away from either a first or second end of a ring when secured between the portion of the fracturable locking pin and the housing.

Referring now to FIGS. 21-30, the fracturable locking pin 102 is adapted to be fractured by only bearing against the portion 106B of the fracturable locking pin rather than the portion 106B of the fracturable locking pin 102 and another structure.

In another example embodiment of the seal, the fracturable locking pin comprises a shaft portion 105 and a fracturable portion, the fracturable portion comprising a fracturable member 117A and a head member having an engagement surface, and wherein the fracturable member is separable from the shaft portion when there is any application of force to the head member.

As shown in FIGS. 21-30, the portion 106B of the fracturable locking pin 102 is adapted to receive at least two opposing forces, the at least two opposing forces being of sufficient magnitude to break the fracturable member.

One example embodiment further comprises a complementary tool 131 adapted to manipulate the head member 106, wherein the at least two opposing forces of sufficient magnitude may be applied to break the fracturable locking pin.

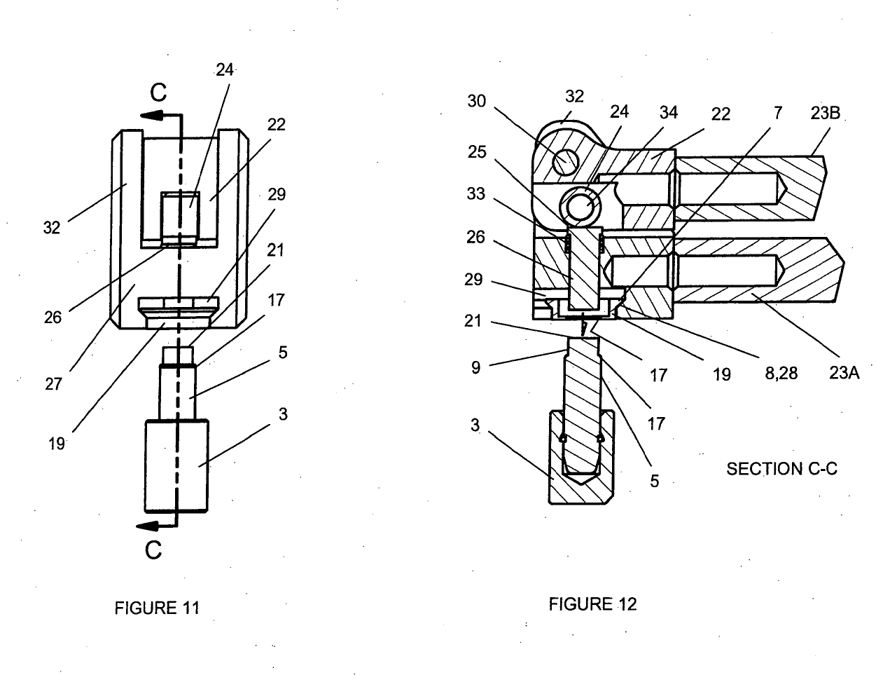

Ideally, in an example embodiment shown in FIGS. 23-31, the complementary tool 131 comprises at least an actuator housing 139 defining a cavity 129 having an interior member 129A adapted to capture at least a part of the head member 106. The outer surface of the head member has a complementary configuration with the interior member 129A of the cavity. The actuator housing further comprises a force-exerting member 124 to in general, axially bear against the portion 106B of the fracturable locking pin 102 to break the fracturable locking pin. The tool 131 ideally further comprises a cam surface 124C which makes acuate contact with force-exerting member 124, as well as a housing, pivoting member 122, two pivot pins 130, 134, an actuating pin 126A, and a spring member 133. The tool further comprises actuating handles 123A, 123B to actuate the actuator housing. It will be appreciated that the tool 131 has several similar operational features to the tool as shown in FIGS. 5-13 (e.g., 28-31, and in particular, page 29, lines 11-27).

Referring now to FIGS. 32A-32D, various views of an embodiment of the fracturable locking pin are illustrated. FIG. 33 is shows of an embodiment illustrating a seal with fracturable locking pin 102 prior to insertion into a housing 103 in accord with a possible embodiment of the present invention. FIG. 34 is shows the fracturable locking pin 102 after insertion into a housing 103.

In other embodiments, the housing includes a translucent outer enclosure and a colored inner enclosure with a bar code panel. Another embodiment provides a housing including a housing forming opening, and a contoured entry member as well as an end member.

In one other example embodiment an apparatus is provided for securing a ring having first and second ends, the ring being adapted to mount a meter to a meter box structure, each of the first and second ends of the ring defining an aperture therein, the apparatus including at least: a locking pin having a distal end adapted to be insertable through each of the apertures of first and second ends of a ring, wherein the locking pin includes at least a head member having at least an engageable end and a fracturable member, the locking pin further including at least a shaft portion with the distal end, the fracturable member being disposed intermediate the engageable end and the distal end of the locking pin; and a lock housing adapted to retain at least a part of the shaft portion. The head member, ideally is adapted to receive at least two opposing forces, the at least two opposing forces being of sufficient magnitude to break the fracturable member. In one other example embodiment of the apparatus, the apparatus further includes at least a complementary tool adapted to manipulate the head member, wherein the at least two opposing forces of sufficient magnitude may be applied to break the fracturable member. One example embodiment of the complementary tool includes at least an actuator housing defining a cavity having an interior surface adapted to capture the head member, the outer surface of the head member being complementary to the interior surface of the cavity, the actuator housing including at least a force-exerting structure to in general, axially bear against the engageable end to break the fracturable member.

In another example embodiment of the apparatus, the fracturable member is disposed immediately adjacent at least one of first and second ends of a ring.

In one other example embodiment a system is provided for creating a seal, the system including at least: means for uniting a plurality of structures; means for retaining the means for uniting, wherein the plurality of structures is secured between at least a portion of the means for uniting and at least a portion of the means for retaining; and means for enabling direct application of opposing forces by a separate object to the at least a portion of the means for uniting, whereby the at least a portion of the means for uniting may be fractured.

In one other example embodiment a method is provided for creating a seal, the method including at least: uniting a plurality of structures, wherein the uniting is carried out with a fracturable locking pin; retaining at least a part of the fracturable locking pin with a lock housing, wherein the plurality of structures is secured between a portion of the fracturable locking pin and at least a portion of the lock housing; and enabling direct application of opposing forces by a separate object to the portion of the fracturable locking pin, whereby the fracturable locking pin may be fractured.

Referring again to the various figures, it should be recognized that in other embodiments, various reference characters (or numerals) may designate the same or similar parts throughout the several views. Various reference characters (or numerals) in other figures may have the same last one or two digits as those in FIGS. 1-17D (e.g., 14 may be the same as 114); where indicated and in many cases as will be apparent to one of ordinary skill in the art, that a part shown in other figures which has the last two digits which are the same as designates the same or similar parts as those parts in FIGS. 1-17D.

In other example embodiments, bolt seals are used to secure many different enclosure types from truck cargo containers to electricity meters. Certain specifications require a bolt seal to withstand a significant axial tensile force. In one embodiment a tool is provided for breaking the head of a sealed bolt type seal. Due to the high tensile force requirements for these seals, a tool to shear the head of the bolt seal from the bolt must provide a significant amount of force on the head of the bolt to break it and allow its sealed contents to be accessed.

An example embodiment is shown in FIG. 45I and comprises a body 4, handles 1 and 7, a cam 9 as shown in FIG. 45N, a punch 10 and a ratchet mechanism 2. Referring to FIG. 45N, the cam 9 makes contact with a roller 6 that is mounted on the punch 10, Force applied to the handles 1 and 7 creates a torque that is applied through the ratchet mechanism 2 to the cam 9. The cam 9 has a gradually increasing diameter 13 or rise that bears on the roller 6 at 14 and forces the pin 10 into the head 3 of the bolt seal 5 in the bolt interacting portion 8 of the tool. The tool is positioned so that the head of the bolt is captured by the bolt interacting portion. As the pin 10 is acted upon by the cam 9, the pin is forced deeply enough into the head of the bolt so as to shear the shank section 11 of the bolt from the head 3 of the bolt and thus allow removal of the seal from the container on which it is installed. In some example embodiments, the cam is designed so as to give mechanical advantage to reduce the force required to be placed on the handles to operate the tool. In the present embodiment the cam has a linear rise over approximately 300 degrees. Once the cam is fully rotated and the head of the bolt has been broken the cam returns back to its starting position and the punch returns to its fully retracted position. A spring 15 is mounted coaxially around the pin in the cavity of the body 4. The spring 15 assists in retracting the pin after the bolt seal is broken.

Many different ratchet devices may be used to drive the cam as will be obvious to those skilled in the art. Many different profiles may be chosen for the cam. A part of the function of the cam in some embodiments is to actuate and allow return of the punch at varying rates and angles of rotation.

Bolt type seals are used for many sealing applications as indicators to ensure that the contents of containers are not accessed without showing evidence. Some examples of containers are truck cargo trailers, shipping containers and electrical enclosures. In the electric utility industry these seals have been adapted to seal meter-sealing rings. Generally these bolt type seals comprise a housing and a locking bolt. The locking bolt is inserted into a locking bolt receiving aperture and is generally captured and retained by an internal retaining member. In many sealing applications once the locking bolt is inserted into the housing, the bolt type seal must be destroyed to open the container. Many current bolt type seals use a split ring to retain the locking bolt in the housing. Typically when the locking bolt is inserted into the housing, one end of the bolt passes through the split ring camming it outward sufficiently to allow the locking bolt to pass through. An annular groove is provided on the end of the locking bolt and the split ring snaps into this groove uniting the housing and the locking bolt. One problem that has been a concern for users of bolt type seals is that the split ring can be removed from the housing allowing the bolt to be inserted and removed without showing any evidence of tampering. Someone desiring to gain access to a sealed enclosure can modify a housing by removing the split ring and freely access the container without showing signs of tampering, yet the enclosure appears to be properly sealed when the locking bolt is in place.

The present invention comprises a seal, the seal comprising: a housing; a locking bolt; and a locking bolt retainer, the locking bolt retainer comprising a locking bolt gripping portion and a housing gripping portion; wherein the housing gripping portion comprises a locking bolt receiving aperture interfering portion.

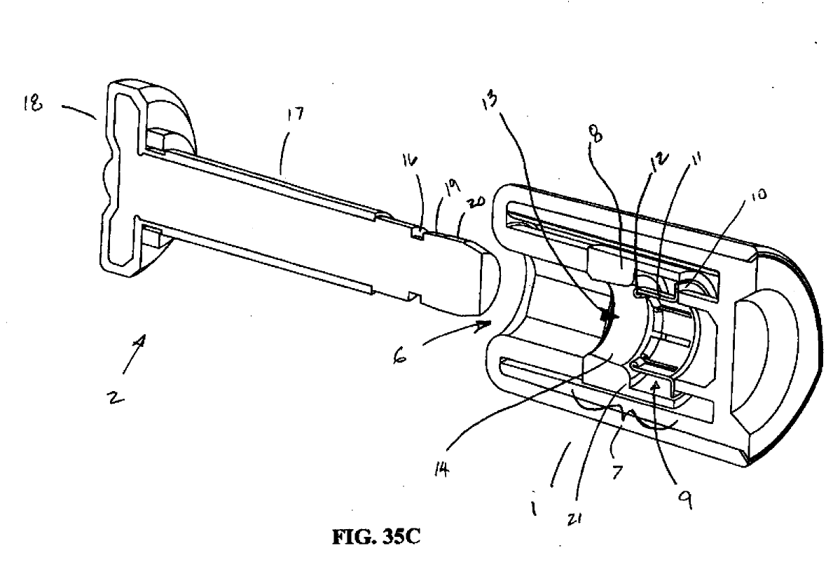

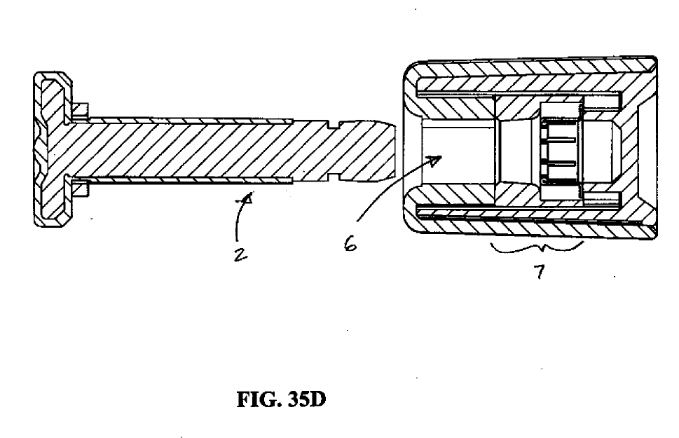

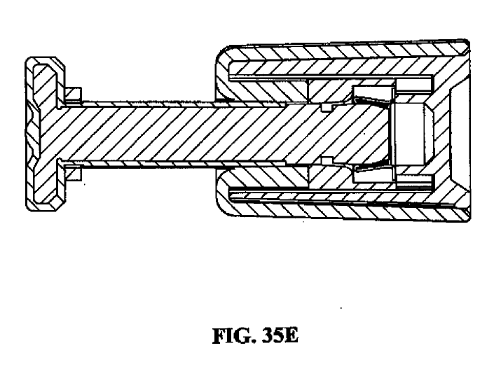

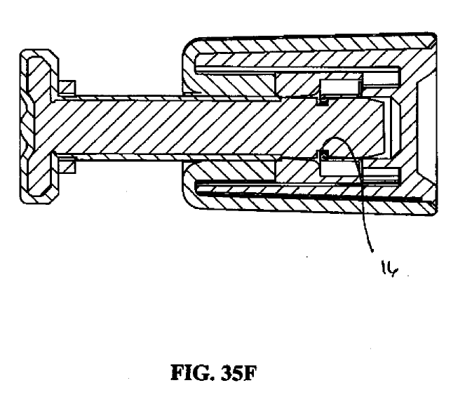

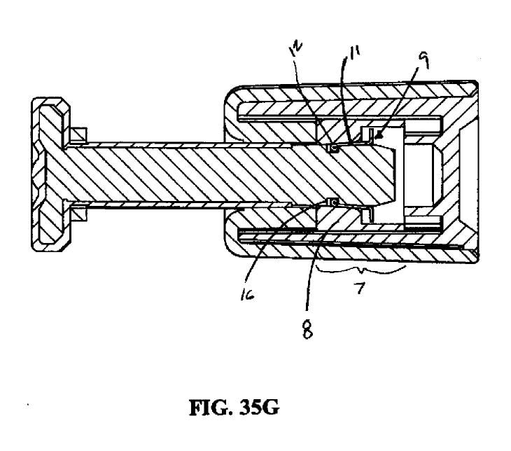

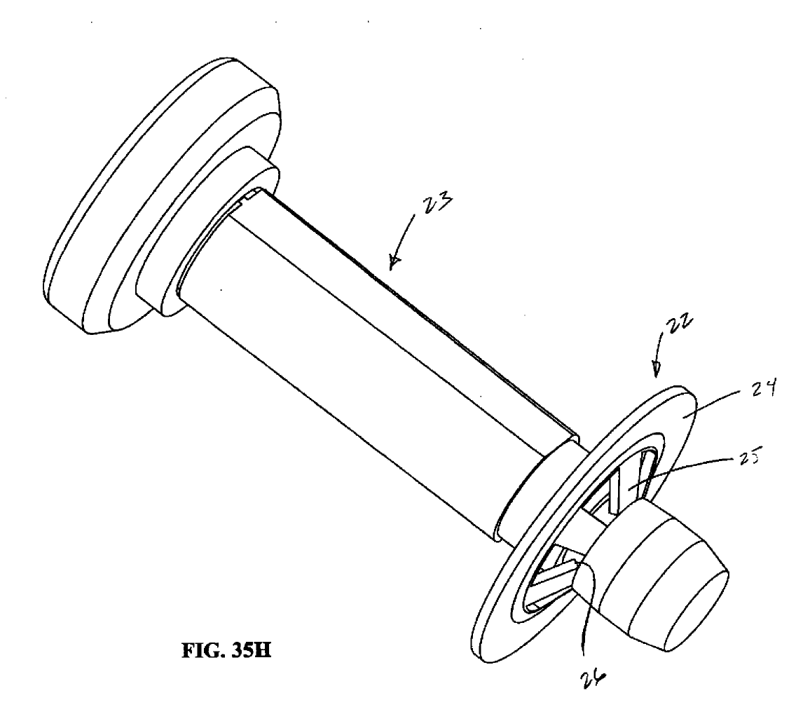

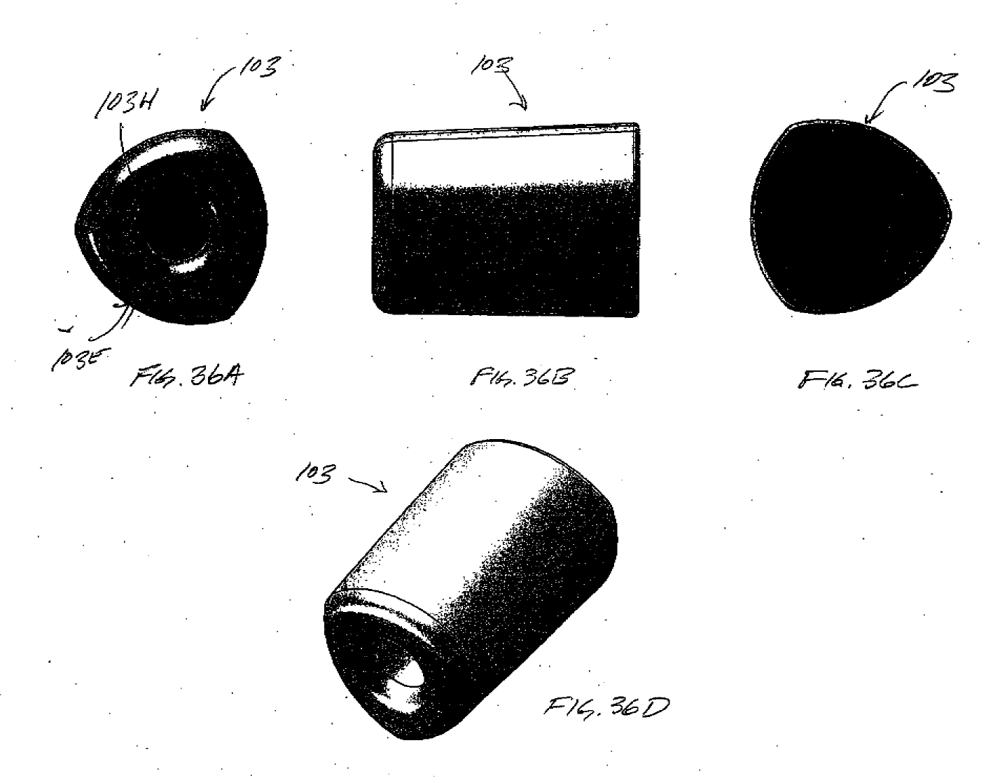

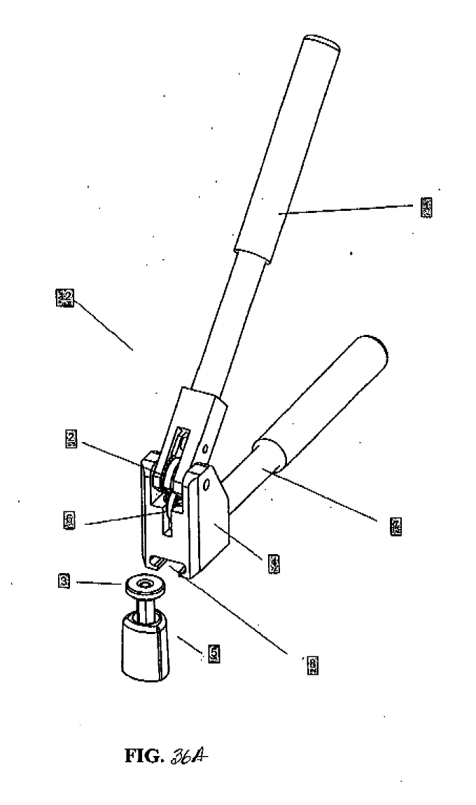

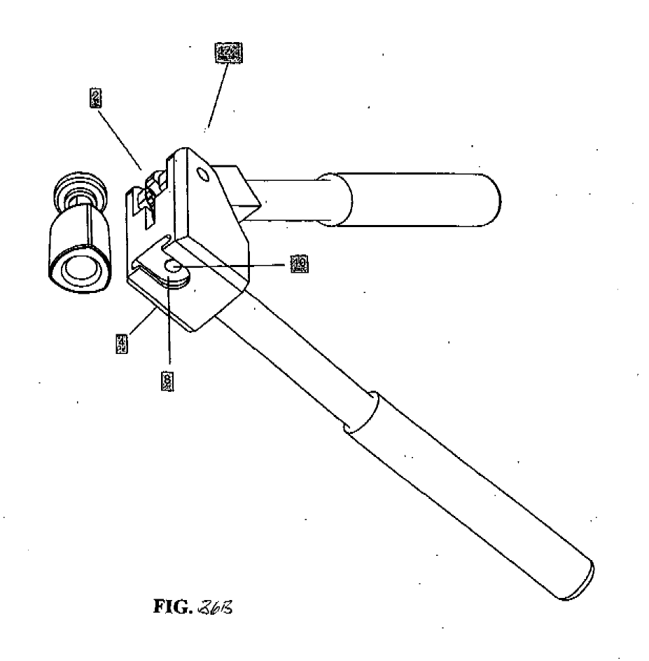

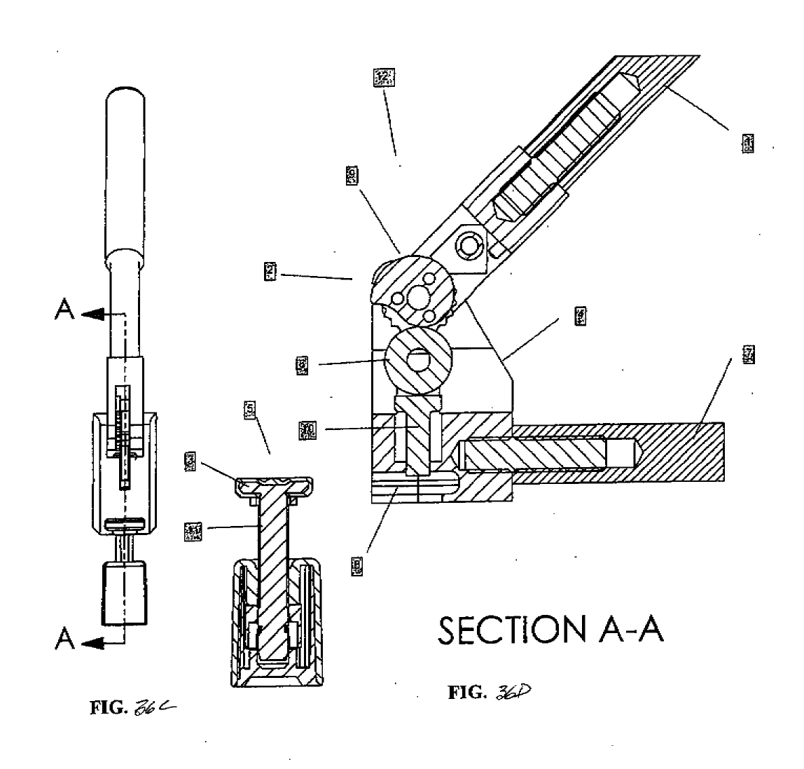

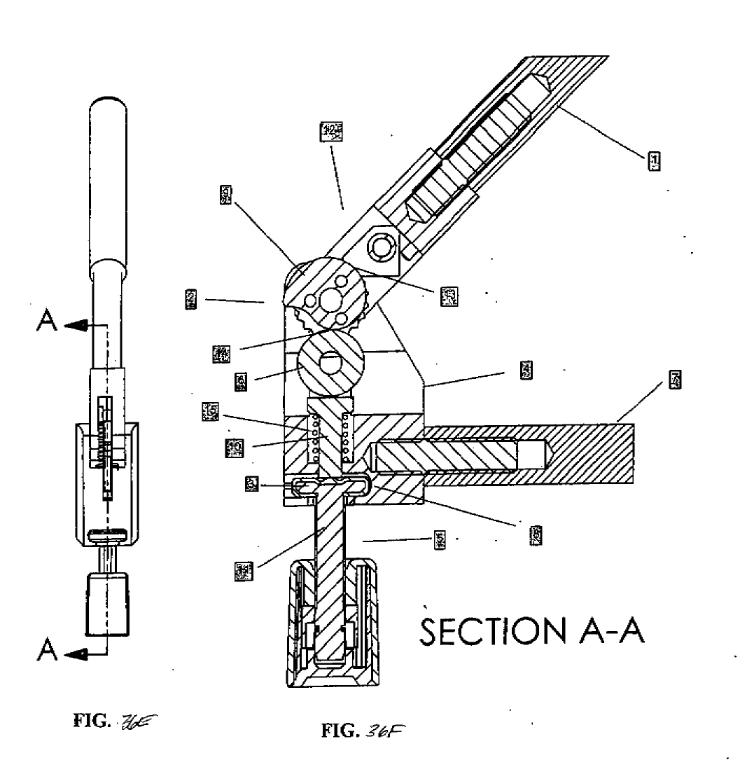

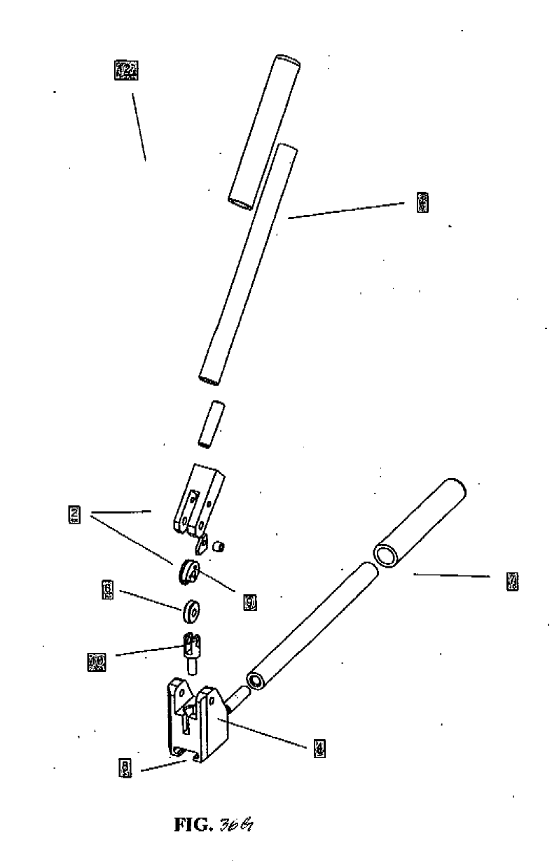

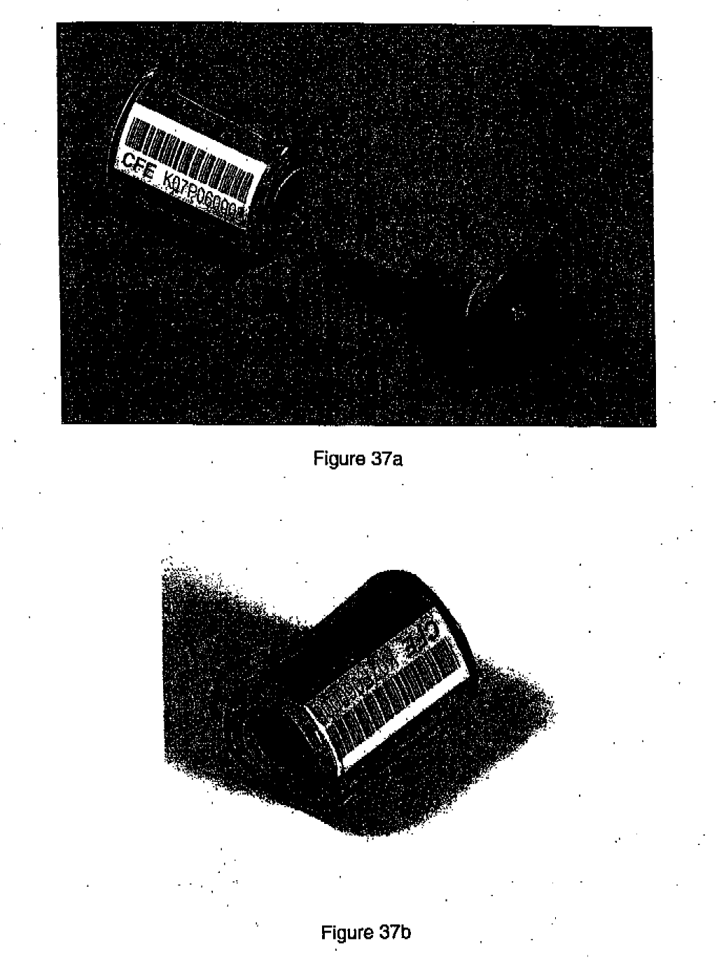

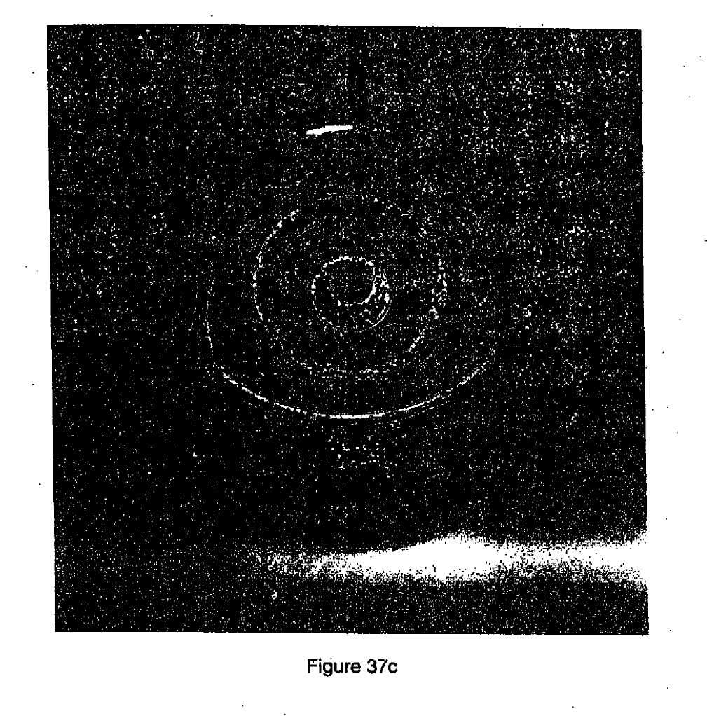

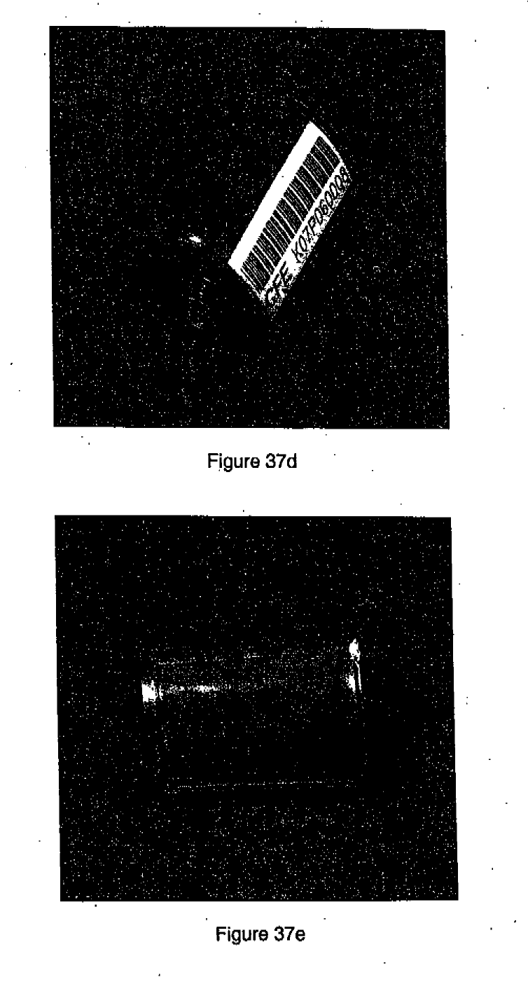

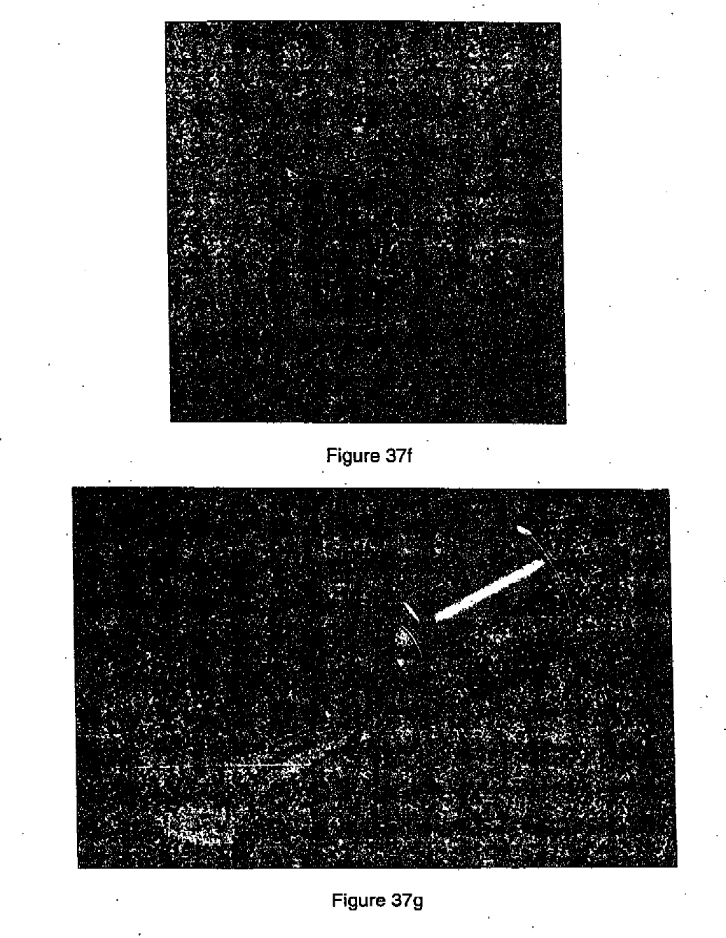

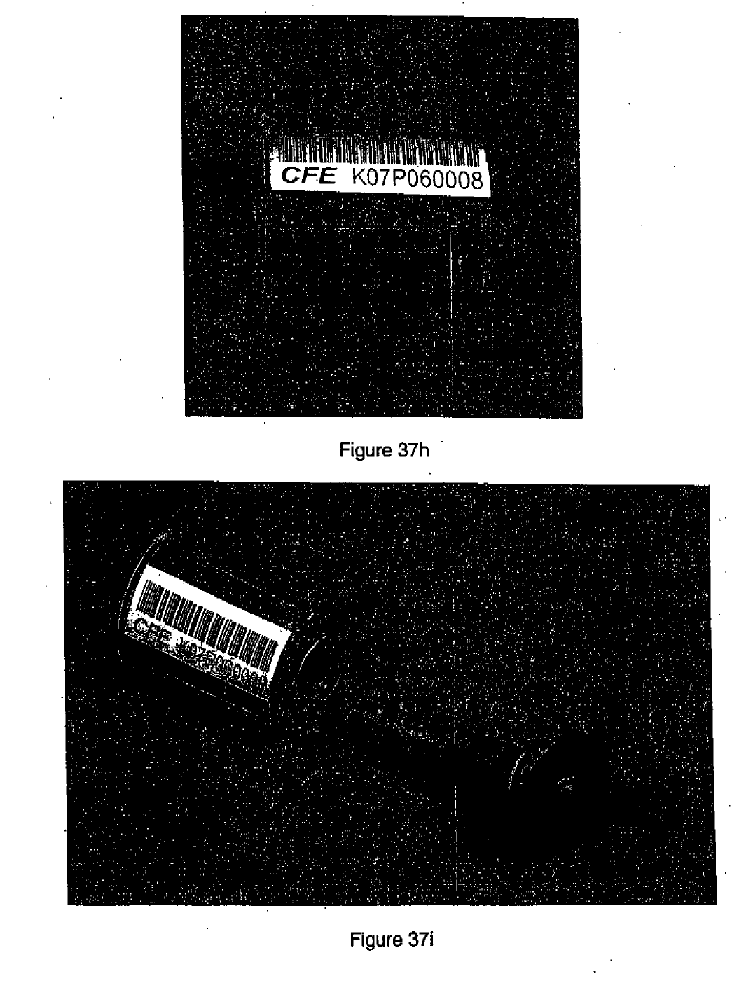

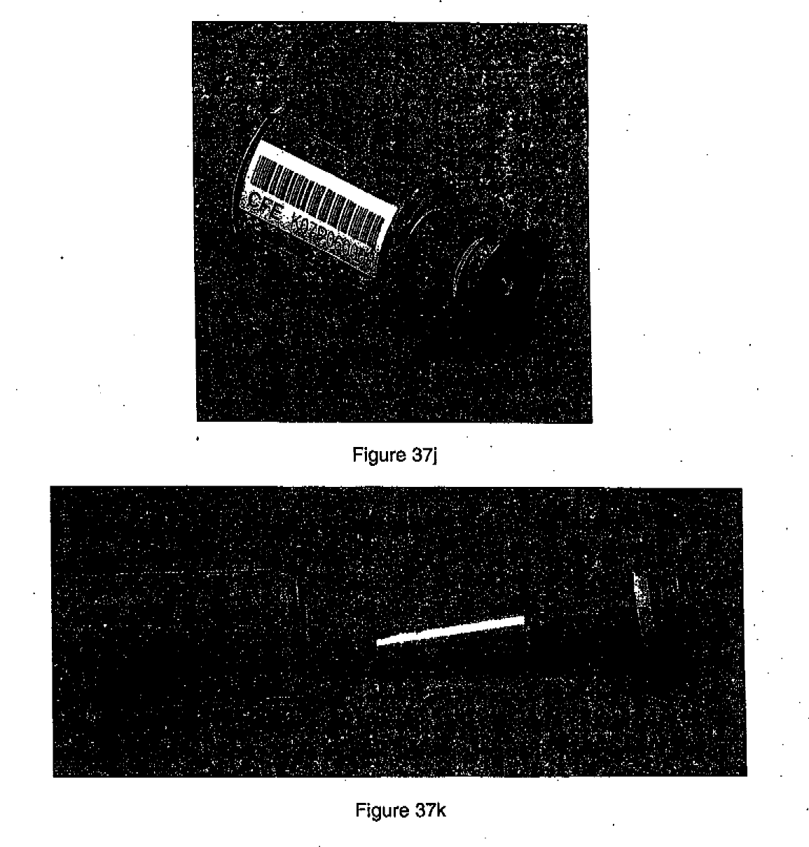

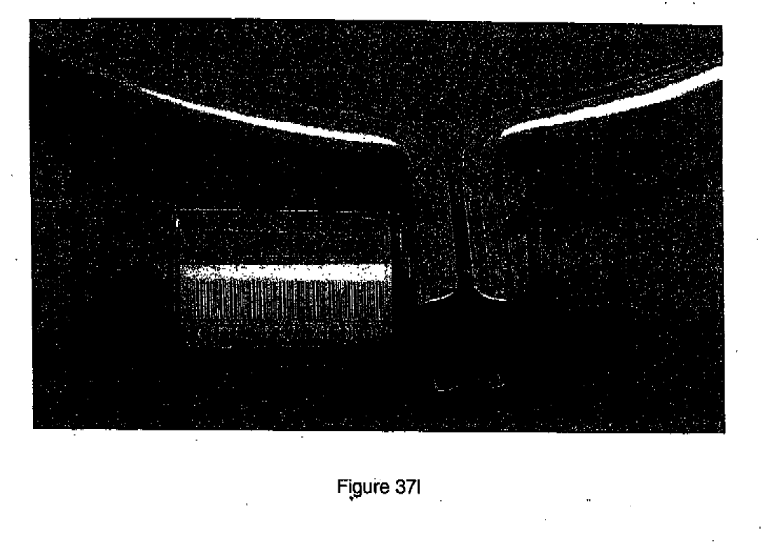

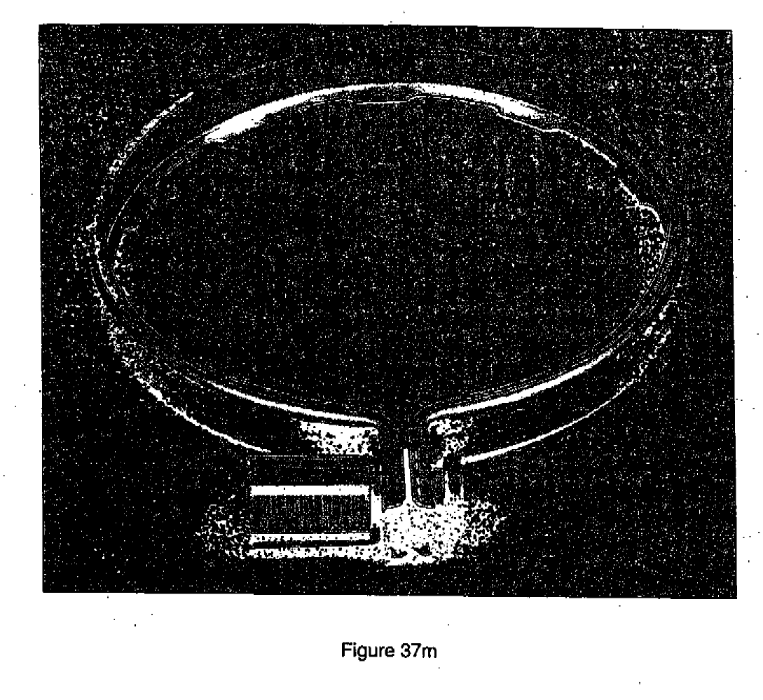

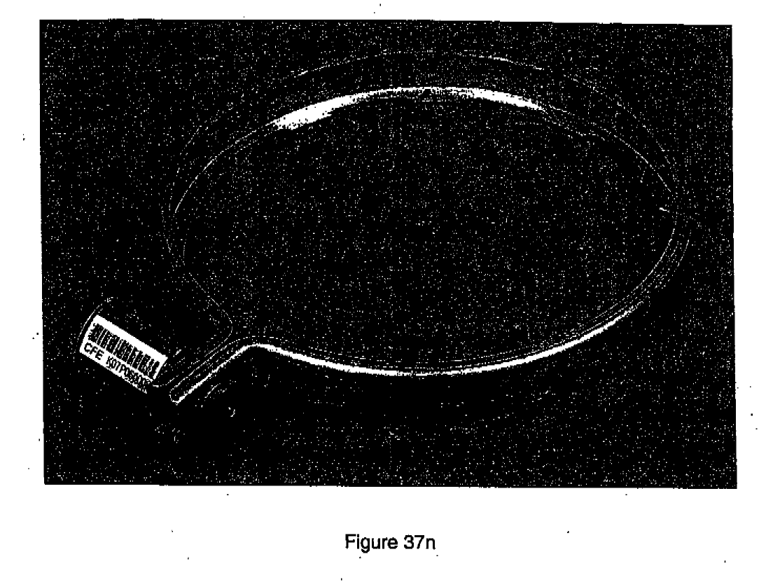

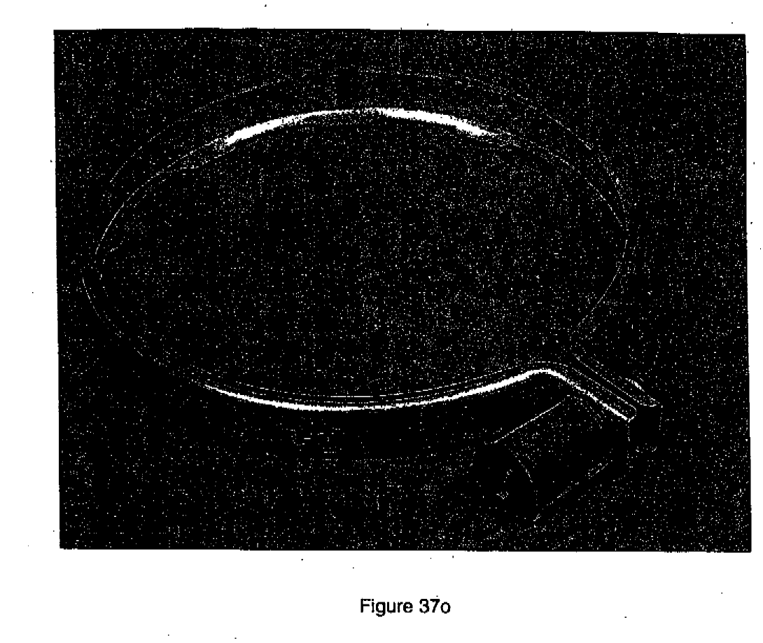

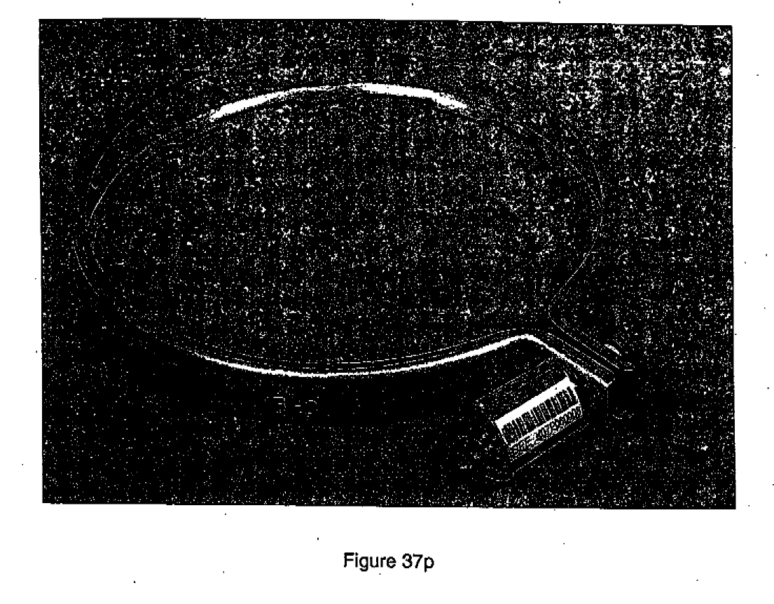

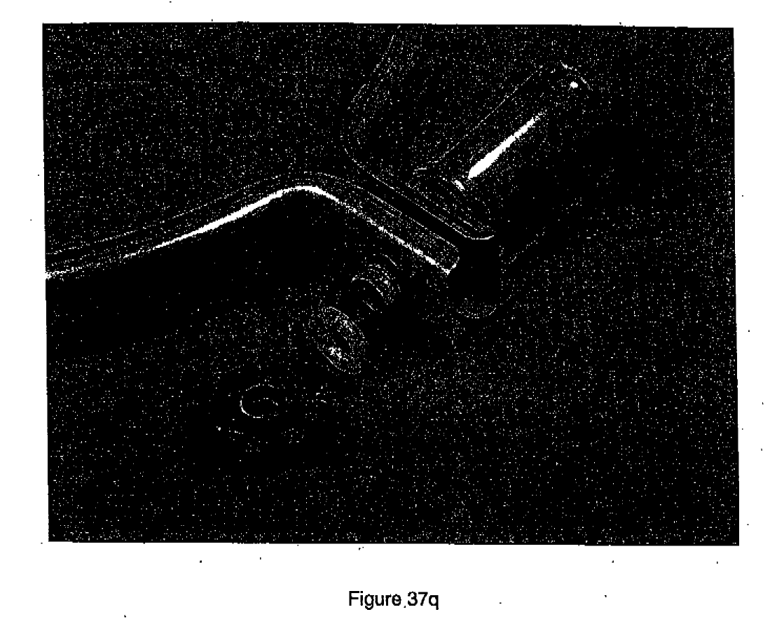

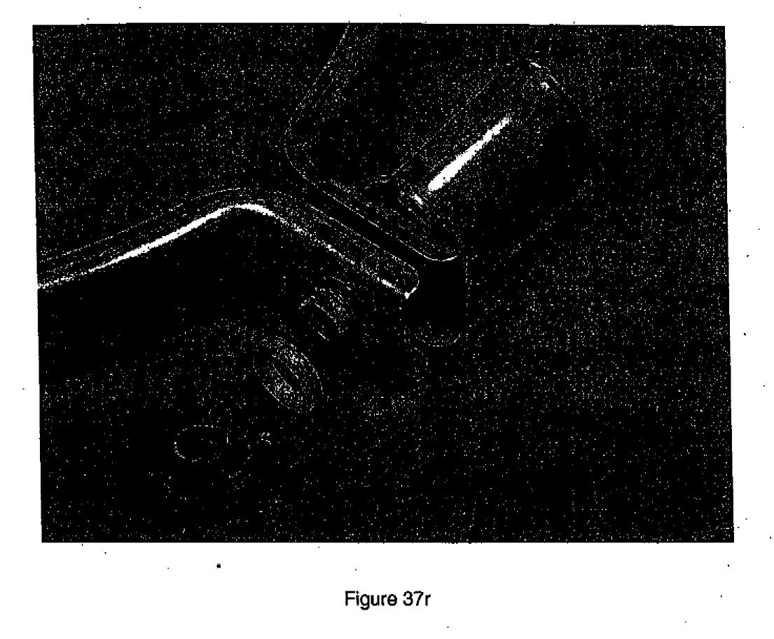

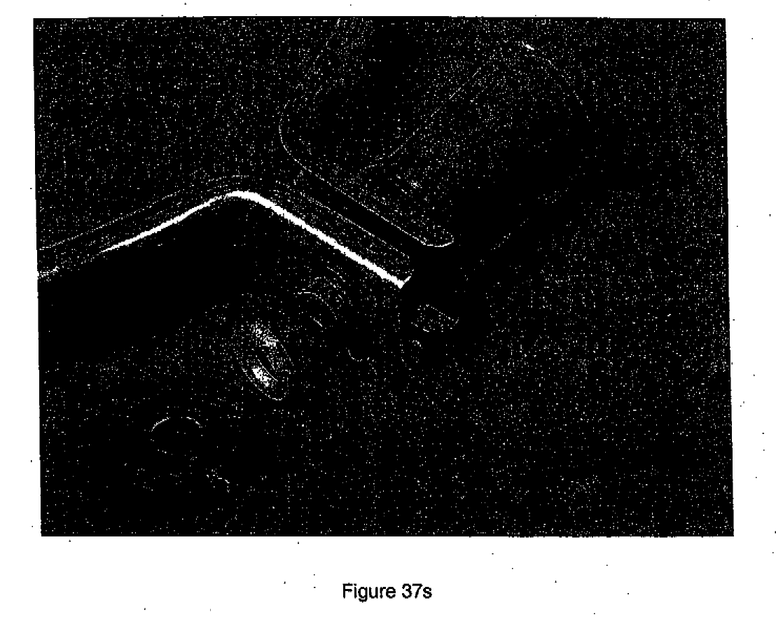

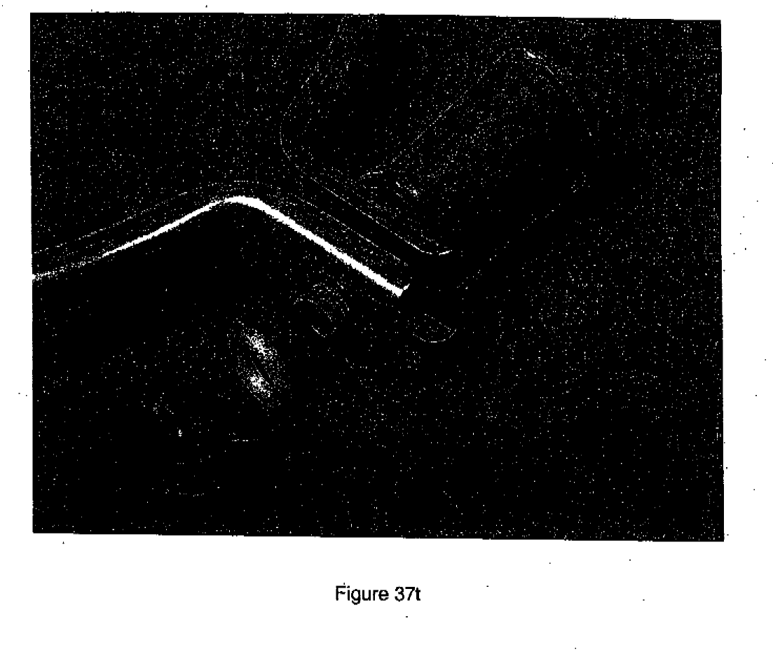

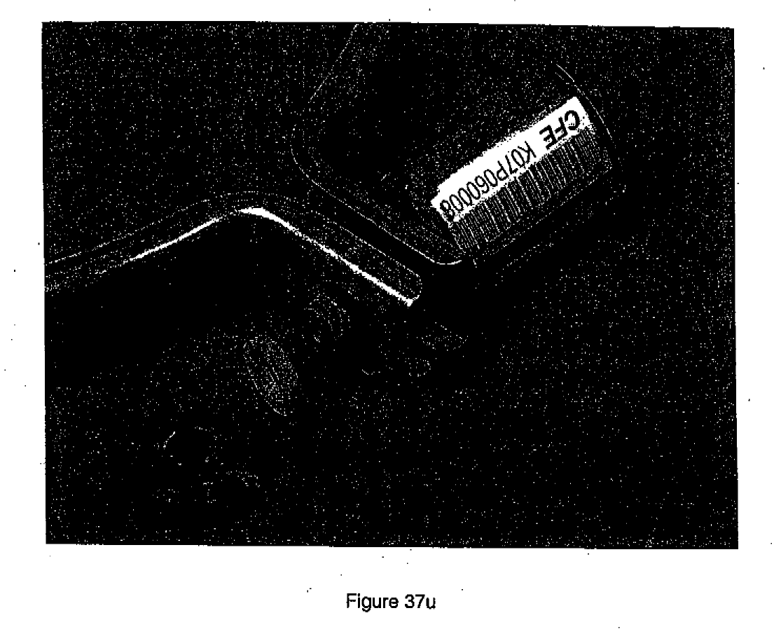

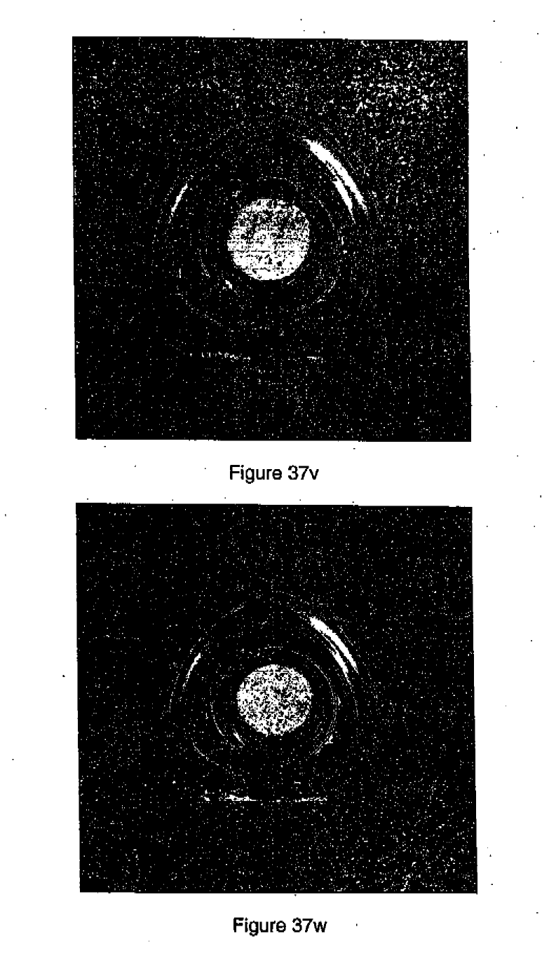

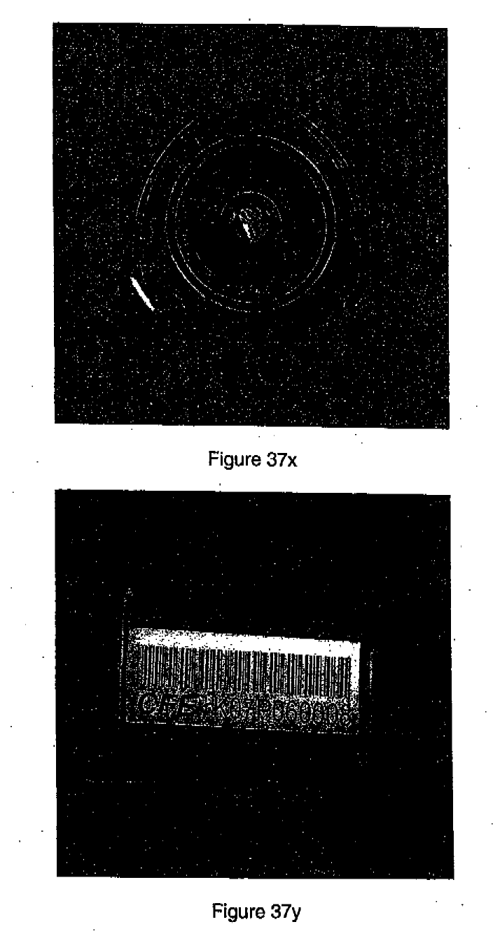

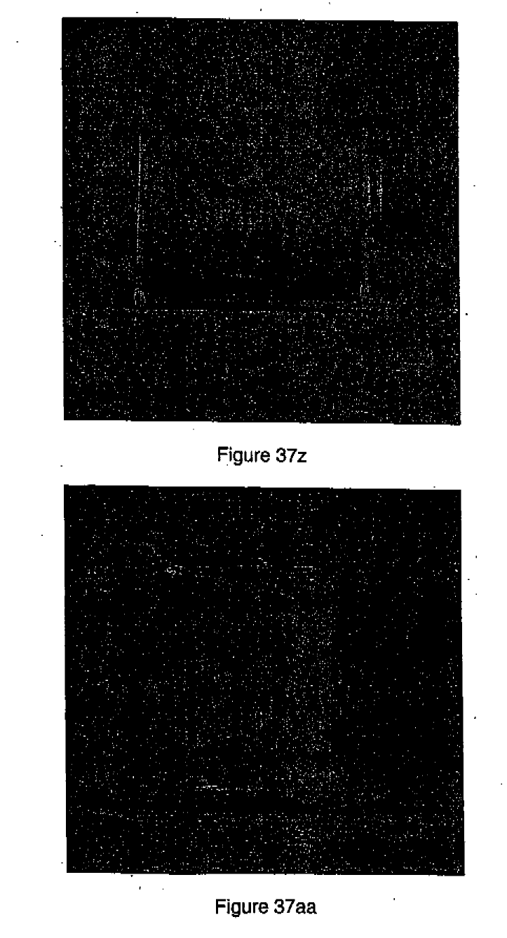

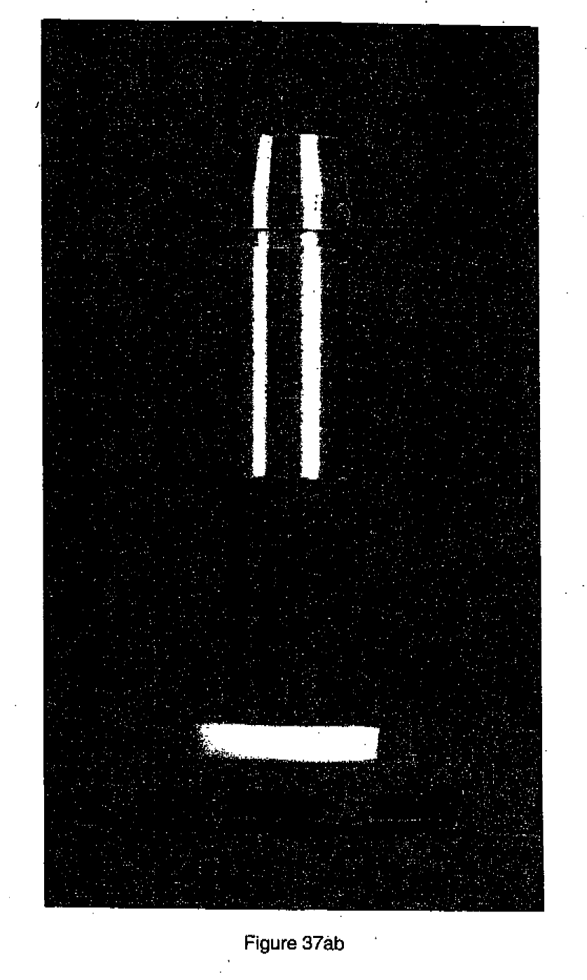

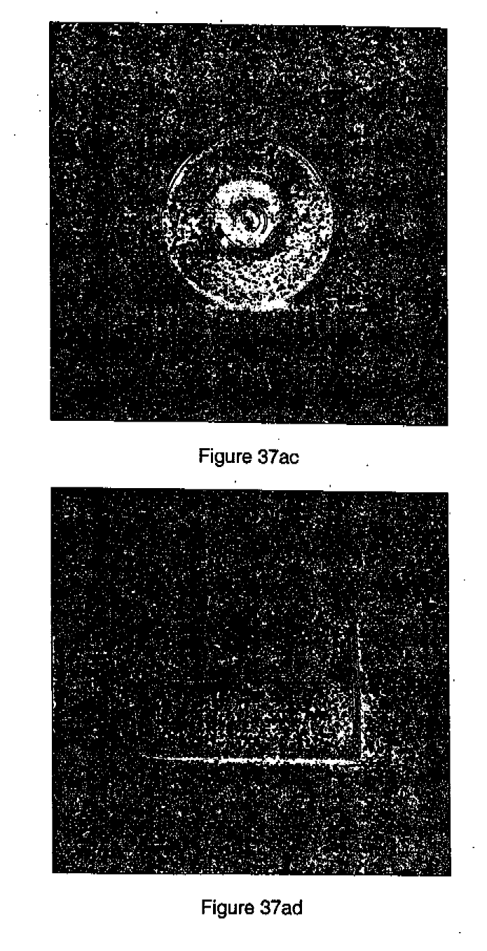

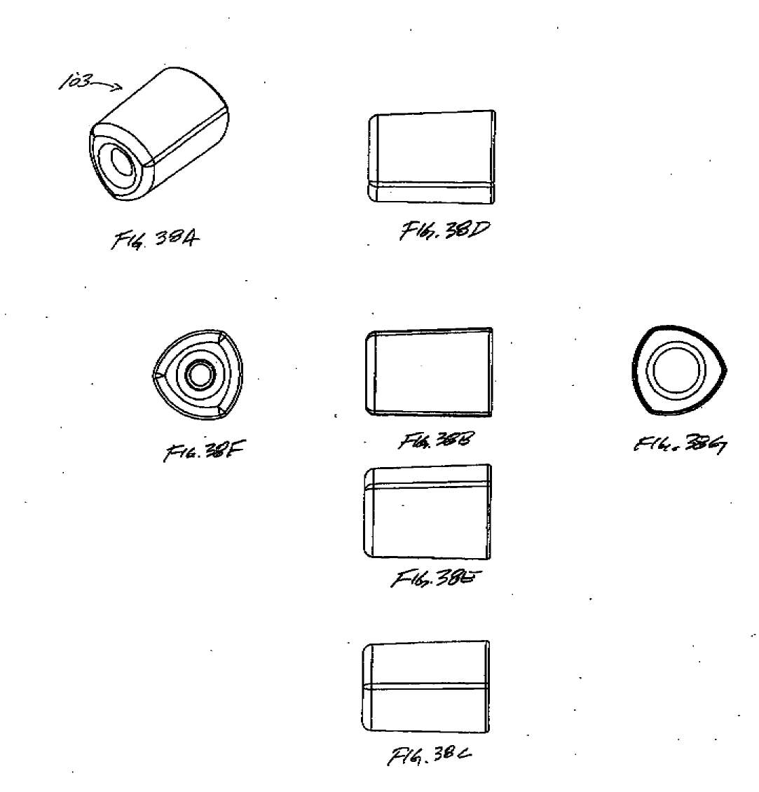

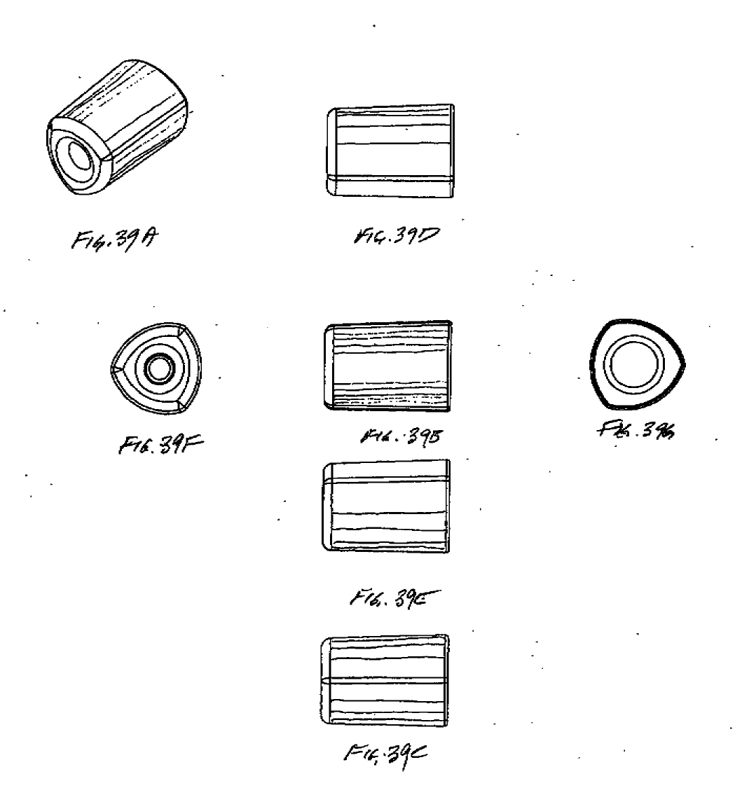

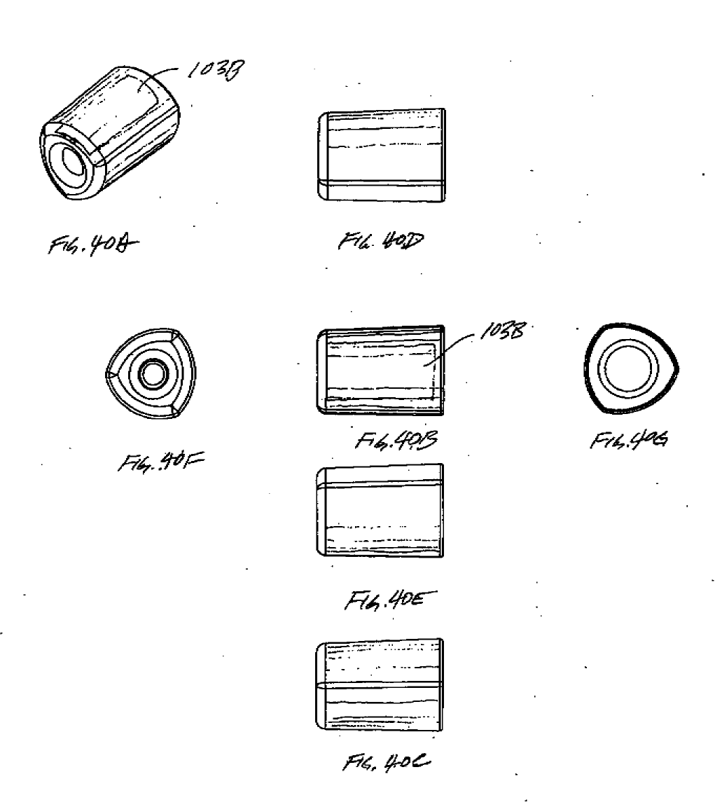

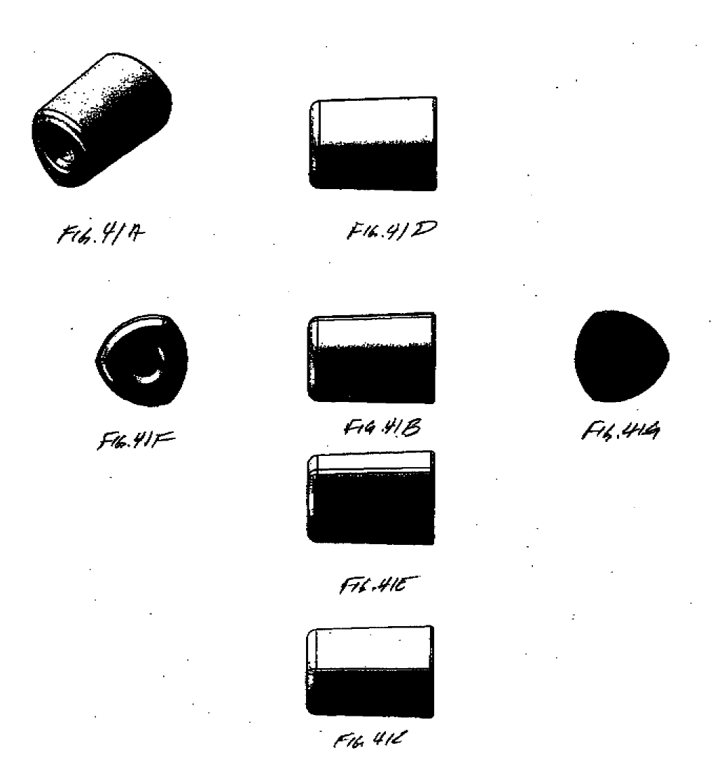

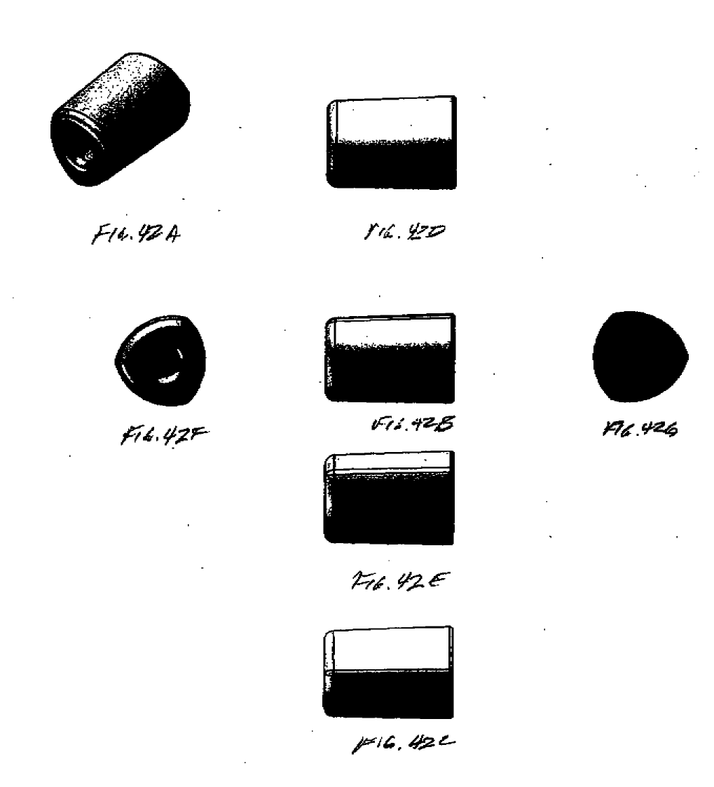

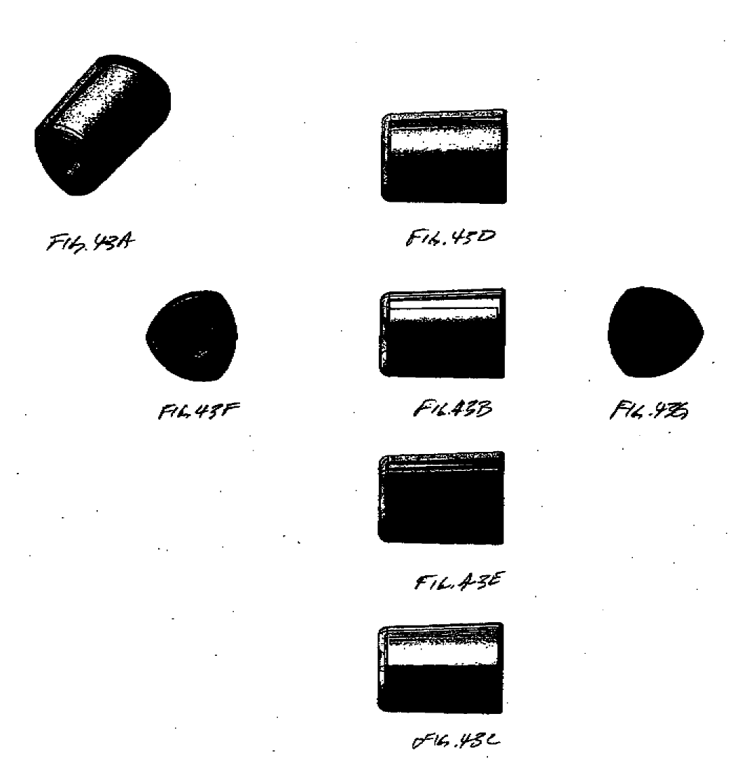

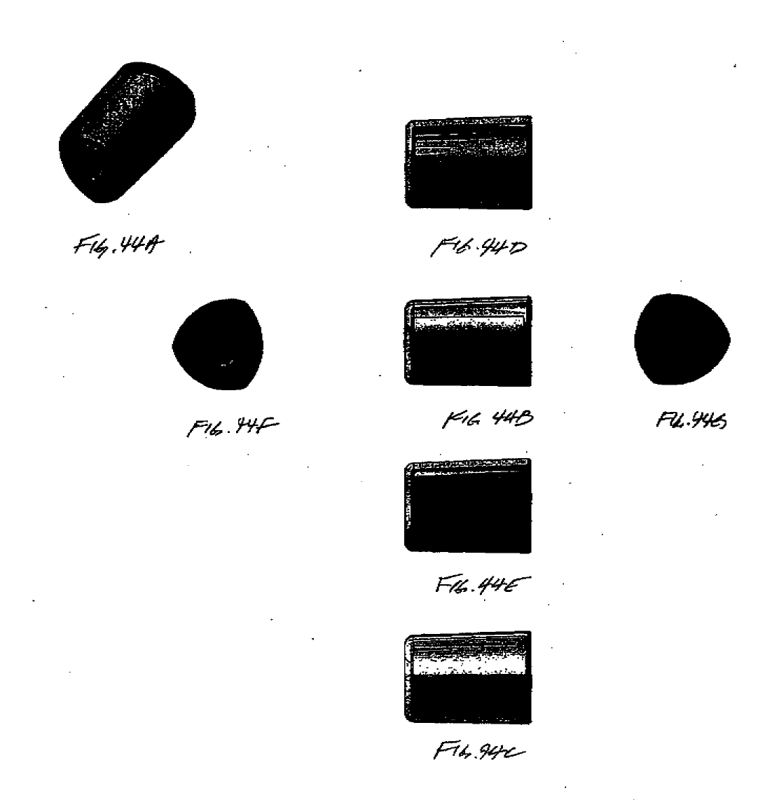

One example embodiment bolt type seal is shown in FIG. 35A and comprises a housing 1 and a locking bolt. FIG. 35B shows the present embodiment installed on a meter sealing ring 3. The locking bolt 2 is inserted through a hole in the ring 3 generally at 4 and the ring is held closed by the housing 1 and locking bolt 2. Once the seal is installed it must be destroyed to open the meter sealing ring. The present embodiment may be to seal many different devices as will be obvious to those skilled in the art and is shown in FIG. 35B as simply an example sealing application.

FIG. 35C shows an example embodiment seal in cross section. FIG. 35C shows the housing 1. which comprises a locking bolt receiving aperture 6. The locking bolt receiving aperture accepts a locking bolt 2. The locking bolt comprises a shaft portion 17 a head portion 18 and a circumferential grove 16. A locking bolt retainer 7 is located generally along the central axis of the locking bolt receiving aperture. Referring to FIG. 35E, the locking bolt is inserted into the locking bolt receiving aperture and into the locking bolt retainer, the locking bolt retainer captures the locking bolt and securely grips it. The gripped configuration is shown in FIG. 35F. Once the locking bolt is gripped by the locking bolt retainer the present invention requires either the locking pin or the housing or both to be destroyed in order to open the meter sealing ring.

Referring to FIG. 35C, the locking bolt retainer can be seen generally at 7. The locking bolt retainer comprises a bushing 8 and a fastening member 9. The fastening member further comprises an interfering portion 10; a flexible connecting portion 11 and a locking pin interacting portion 12. The bushing comprises a locking bolt receiving aperture 13, a fastening member closing portion 14.

FIGS. 35D-35F show the sequence of operation of the seal. To begin the locking bolt 2 is aligned with the locking bolt receiving aperture 6 and inserted into the aperture. When the end of the locking bolt contacts the fastening member 9 slight force is exerted to bend the flexible connecting portion 11 outward and allow the end of the locking bolt to enter the fastening member as shown in FIG. 35E. Once the locking bolt is inserted sufficiently the locking pin interacting portion 12 can snap into the circumferential groove 16 in the locking pin as shown in FIG. 35F.

FIG. 35G shows the gripping action of the locking bolt retainer 7. When sufficient force is exerted on the locking bolt to attempt to remove it from the housing, the fastening member 9 is pulled with the locking bolt as a result of interaction between the locking pin interacting portion 12 and the circumferential grove 16 in the locking bolt. As both members move they are drawn into the bushing 8 and the flexible connecting portion 11 is cammed inward by the fastening member closing portion 14. The locking bold has tapered portion 19 as seen in FIG. 35C. The tapered portion allows the flexible connecting portion to nest tightly against the locking pin and wedge into the bushing. Further tension on the locking pin forces the tapered surfaces against each other. The diameter of the end of the locking bolt at 20 shown in FIG. 35C is sufficiently large so that when combined with the thickness of the flexible connecting portion it provides an interference fit and prevents removal of the locking bolt from the housing.

Referring to FIG. 35C, if an attempt is made to remove the fastening member from the housing, the interfering portion 10 of the fastening member would abut the bushing 8 generally at and since its diameter is larger than the diameter of locking bolt receiving aperture 13 in the bushing and the locking bolt receiving aperture 6 in the housing it will be prevented from being extracted.

FIG. 35H shows another example embodiment. The example embodiment in FIG. 35H uses a disk shaped fastening member shown generally at 22. The view in FIG. 35H shows the fastening member as it would appear with the bushing and housing members removed arid with the locking bolt 23 inserted. The fastening member 22 of the current embodiment comprises an interfering portion 24; flexible connecting portions 25 and locking pin interacting portions 26.

In another example embodiment, the locking bolt retainer comprises a split ring that is attached to a locking bolt receiving aperture interfering portion. The attachment on this embodiment comprises an elastomer material that is bonded to the split ring. The elastomer allows the split ring to flex to allow insertion and engagement of the locking pin yet keeps the split ring united with the interfering portion. Other example embodiments use a flexible filament attached to the interfering portion and the split ring. Still other example embodiments comprise flexible leaves spaced around the split ring attaching the split ring to the interfering portion.

One function of the interfering portion is to prevent the split ring from being removed from the housing. In the present embodiment shown in FIG. 35C, the interfering portion 10 is a solid ring comprised of steel. Other example embodiments could comprise other metals, plastics ceramics, composites or other materials with sufficient strength to inhibit extraction through the locking bolt receiving aperture.

Other example embodiments could make use of interfering portions with other shapes. The embodiment shown in FIG. 35C shows a ring shape; other embodiments comprise a square, hexagon, octagon, triangle, star, or irregular profile. The specific shape of the interfering portion can take on numerous shapes that are of sufficient size and geometry to impede its extraction through the locking bolt receiving aperture.

The design described does not limit the scope of the embodiments of invention; the number of various elements may change, or various components may he added or removed to the above-described concept, for example, to aid in improved security and operation.

The foregoing disclosure and description of embodiments of the invention is illustrative and explanatory of the above and variations thereof, and it will be appreciated by those skilled in the art, that various changes in the design, organization, order of operation, means of operation, equipment structures and location, methodology, the use of mechanical equivalents, such as different types of fasteners and locking devices than as illustrated whereby different steps may be utilized, as well as in the details of the illustrated construction or combinations of features of the various elements may be made without departing from the spirit of the embodiments of the invention. As well, the drawings are intended to describe various concepts of embodiments of the invention so that presently preferred embodiments of the invention will be plainly disclosed to one of skill in the art but are not intended to be manufacturing level drawings or renditions of final products and may include simplified conceptual views as desired for easier and quicker understanding or explanation of embodiments of the invention. As well, the relative size and arrangement of the components may he varied from that shown and the embodiments of the invention still operate well within the spirit of the embodiments of the invention as described hereinbefore and in the appended claims. Thus, various changes and alternatives may be used that are contained within the spirit of the embodiments of the invention.

Accordingly, the foregoing specification is provided for illustrative purposes only, and is not intended to describe all possible aspects of the example embodiments of the invention. It will be appreciated by those skilled in the art, that various changes in the ordering of steps, ranges, interferences, spacings, hardware, and/or attributes and parameters, as well as in the details of the illustrations or combinations of features of the methods and system discussed herein, may be made without departing from the spirit of the embodiments of the invention. Moreover, while various embodiments of the invention have been shown and described in detail, those of ordinary skill in the art will appreciate that changes to the description, and various other modifications, omissions and additions may also be made without departing from either the spirit or scope thereof.

### REFERENCES

The following references, to the extent that they provide exemplary procedural or other details supplementary to those set forth herein, are specifically incorporated herein by reference.

U.S. Pat. No. 5,161,838

U.S. Pat. No. 6,406,074

U.S. Pat. No. 5,413,393

U.S. Pat. No. 5,120,097

What is claimed is:

1. An apparatus for connecting and disconnecting first and second ends of a ring, the ring being adapted to mount a meter to a meter box structure, each of the first and second ends of the ring defining an aperture therein, the apparatus comprising:
a locking pin having a distal end adapted to be insertable through each of the apertures of the first and second ends of the ring, wherein the locking pin comprises a head member having at least an engageable end and a fracturable member, the locking pin further comprising a shaft portion having the distal end, the fracturable member being disposed intermediate the engageable end and the distal end of the locking pin; and
a lock housing adapted to retain at least a part of the shaft portion, the first and second ends of the ring being connected between the head member of the locking pin and the lock housing, wherein the head member has an outer surface adapted to receive at least two opposing forces, the at least two opposing forces being of sufficient magnitude to break the fracturable member.

2. An apparatus for creating a seal, the apparatus comprising:
a locking pin adapted to unite a plurality of structures; and
a lock housing adapted to retain at least a part of the fracturable locking pin,
wherein the plurality of structures is secureable between a portion of the fracturable locking pin and at least a portion of the lock housing, and
wherein the portion of the fracturable locking pin is adapted to receive direct application of opposing forces by a separate object, whereby the fracturable locking pin may be fractured.

3. The apparatus of claim 2, further comprising a stress-concentration member to concentrate stress at a desired location on the fracturable locking pin.

4. The apparatus of claim 3, further comprising a further stress-concentration member to concentrate stress at a desired location on the fracturable locking pin.

5. The apparatus of claim 4, wherein the fracturable locking pin further comprises a shaft portion, and wherein the further stress-concentration member comprises a groove formed in at least a portion of the shaft portion.

6. The apparatus of claim 4, wherein the fracturable locking pin further comprises a shaft portion, and wherein the further stress-concentration member comprises an annular groove formed in the shaft portion.

7. The apparatus of claim 3, wherein the fracturable locking pin comprises first and second shaft sections, a fracturable member disposed between the first and second shaft sections, and a head section.

8. The apparatus of claim 3, further comprising a further stress-concentration member to concentrate stress on the fracturable member in a region within a projected area of the second shaft section.

9. The apparatus of claim 7, further comprising a further stress-concentration member to concentrate stress on the fracturable member, in a region within a projected area of the diameter of the second shaft section.

10. The apparatus of claim 7, further comprising a further stress-concentration member to concentrate stress on the fracturable member, and wherein further stress-concentration member to concentrate stress on the fracturable member is in functional cooperation with the relative diameters of the first and second shaft sections.

11. The apparatus of claim 2, further comprising a fracture-configuration-control member to control configuration of fracture of the fracturable locking pin.

12. The apparatus of claim 2, wherein the portion of the fracturable locking pin comprises a head member disposed substantially near an outer side of one of the plurality of structures.

13. The apparatus of claim 12, wherein the portion of the fracturable locking pin comprises a head section and an engageable end.

14. The apparatus of claim 2, wherein the portion of the fracturable locking pin comprises a head section and an engageable end.

15. A seal comprising:
a fracturable locking pin adapted to unite a plurality of structures;
a housing adapted to retain at least a part of the fracturable locking pin,
wherein the plurality of structures may be secureable between a portion of the fracturable locking pin and the housing,
and wherein the portion of the fracturable locking pin is adapted to receive direct application of opposing forces by a separate object, whereby the fracturable locking pin may be fractured; and
an indication member adapted to reveal evidence of any application of force to the indication member.

16. The seal of claim 15, wherein the portion of the fracturable locking pin is adapted to receive at least two opposing forces, the at least two opposing forces being of sufficient magnitude to break the fracturable member.

17. The seal of claim 16, and further comprising a complementary tool adapted to manipulate the outer surface of the head member, wherein the at least two opposing forces of sufficient magnitude may be applied to break the fracturable locking pin

18. An apparatus for securing a ring having first and second ends, the ring being adapted to mount a meter to a meter box structure, each of the first and second ends of the ring defining an aperture therein, the apparatus comprising:
a locking pin having a distal end adapted to be insertable through each of the apertures of first and second ends of a ring, wherein the locking pin comprises a head member having at least an engageable end and a fracturable member, the locking pin further comprising a shaft portion with the distal end, the fracturable member being disposed intermediate the engageable end and the distal end of the locking pin; and
a lock housing adapted to retain at least a part of the shaft portion.

19. The apparatus of claim 18, wherein the head member has is adapted to receive at least two opposing forces, the at least two opposing forces being of sufficient magnitude to break the fracturable member.

20. The apparatus of claim 19, wherein the apparatus further comprises a complementary tool adapted to manipulate the head member, wherein the at least two opposing forces of sufficient magnitude may be applied to break the fracturable member.
